(19) United States
(12) Patent Application Publication
(10) Pub. No.: US 2015/0356250 A1
(43) Pub. Date: Dec. 10, 2015

(54) Method for an Interactive, Patient Controlled Medical Information System in a Digital, Real Time Manner which Features a Single Point of Entry for Patients, Physicians, all other Health Care Providers, Health Care Payers, Researchers and Pharmaceutical Companies

(71) Applicant: Marc Polimeni, Oradell, NJ (US)

(72) Inventor: Marc Polimeni, Oradell, NJ (US)

(73) Assignee: POLIMENI MEDICAL INFROMATION TECHNOLOGIES, LLC, Oradell, NJ (US)

(21) Appl. No.: 14/731,293

(22) Filed: Jun. 4, 2015

Related U.S. Application Data
(60) Provisional application No. 62/007,580, filed on Jun. 4, 2014.

(51) Int. Cl. G06F 19/00; H04L 29/08

(52) U.S. Cl. CPC G06F 19/322; G06F 19/3406; H04L 67/02; G06F 19/3418

(57) ABSTRACT

A system and method of managing and maintaining electronic health care records on a web based database controlled by the patient where the electronic health care records are updated on the web based database immediately at the point of service. A user patient logs into the system and authorizes health care providers to have access to that user patient's medical records database. These health care providers generate electronic medical records pertaining to the user patient. These electronic medical records are uploaded onto the user patient's database and sorted by HL7/FHIR resource code in that database. The electronic medical records are immediately available to the patient and authorized health care providers through the patient's medical records management system database. Additionally, the electronic medical records of all patients on the medical records management system database are available to be searched as a function of medically relevant data stored on the database.

### PRIORITY

This application claims priority to U.S. Provisional Application No. 62/007,580 filed Jun. 4, 2014.

### BACKGROUND OF INVENTION

The present invention is directed to a system and method of creating and implementing a living medical chart or living chart of patient-controlled interactive database of electronic medical records (EMRs) on mobile devices, tablets and other web based platforms that provide a central repository for all patient health care information and family medical history. The database is accessible to all of the patient's health care providers and operates as a single point of entry for all health care providers including but not limited to, treating physicians, hospitals, diagnostic testing facilities, pharmacies and patients. The patient-controlled interactive database created by the system and implemented by the method disclosed here is also accessible to third-parties to the patient/health care provider relationship including insurance companies, pharmaceutical companies, government agencies, research facilities and other groups interested in patient-identify neutral data mining and analysis for treatment development. Specifically by way of example, the administration of vaccines to children in a certain geographic region or specific area or group, the efficacy or threat of side effects or health risks of certain drugs within prescribed populations, the effectiveness of procedures and treatment protocols within defined populations.

The present invention presents a system and method where EMRs in native and Health Level 7 International/Fast Healthcare Interoperability Resources (HL7/FHIR) format are imported and translated, when in native format, into HL7/FHIR format and marked with the corresponding HL7 resource type. These EMRs are then saved onto the patient controlled interactive database (the living chart) by patient user identity markers contained in the data in the HL7 resource type. Further, the EMRs are then categorized and placed in the patient database based on International Statistical Classification of Disease and Related Health Problems 9 code (ICD) and its successor code in the EMR.

The system and method of the present invention provides a single point of entry for patients and health care providers to a database which holds all of the patient's medical information in HL7 format with all of its associated operability. The patient provides access to health care providers as the patient seeks treatment or care from the health care provider. In this way, the present invention affords the patient with control over his or her medical information. Moreover, the patient's entire medical history, from diagnostic testing, physician treatment notes through family history, is in a centralized location making it easier and more efficient to access and use. The creation and use of this patient living chart provides for better treatment outcomes, more efficient use of treatment services and longer and healthier patient lives.

Presently, the gathering and storage of patient information by health care providers is not maintained pursuant to one storage protocol. Instead, some health care providers still use and maintain paper records. These papers records—including medical treatment and diagnosis notes—are often physically maintained in folders. Other health care providers scan these paper records into a local hard disk or server and thereby transform these paper medical records into EMRs without functionality or operability. Still other health care providers enter the patient medical information directly into a storage device (e.g., a local server or off-site data repository) and thereby create an EMR which—depending on the sophistication of the digital storage device—sometimes has functionality and operability.

Despite various government incentives to create digital, permanent EMRs for its citizens, there is no real protocol in place, currently, which moves toward this goal. Instead, the methods of storage referenced above, and various and sundry combinations are largely the means by which patient medical records are recorded and stored. As such, the present state of patient medical records storage is far from uniform and currently not moving toward a fully integrated EMR system solution.

The problems associated with storing medical information in a paper form are well known in the art. In the United States, paper records are typically stored for seven years after which time they are destroyed. Data captured on paper is often illegible to third parties and in certain circumstances to the author overtime. A health care provider most often memorializes notes on paper when the provider is administering the service to the patient (point of service). This process is lacking because at the point of service, the health care provider is not informed by data necessary to make a complete entry (e.g., laboratory tests, pathology reports, radiography complete with digital images, radiologist interpretation, and consultation with specialists). As such, the paper note made by the physician at the point of service is isolated from relevant data and arguably of little value until the necessary data garnered from the down-stream tests and analysis are available. However, because the note is dated and entered on paper at the point of service, it stands alone. The hand-written note can be modified or supplemented at a later date when all relevant data is available, but in practice this is rarely the case. As a result, the hand-written notes of health care providers at the point of service in this scenario are of little treatment value.

Current EMR systems maintained by health care providers often stand-alone isolated from connectivity or operability with other health care providers and/or the patient. The systems most often employed, currently, take the form of a server in the health care provider's facility or in an off-site storage location. The information technology used by various health care providers (e.g., physicians, hospitals, nursing homes, surgery centers, diagnostic testing facilities) is far from uniform and there is no accepted and universally employed platform on which EMRs can be stored so that it is easily shared among health care providers and patients.

This disconnected and sometimes non-uniform regimen of storing and accessing EMRs makes for a wasteful patchwork of isolated, nonintegrated patient data that is difficult to access and marshal. As a result, patient outcomes suffer as do treatment efficiencies and preventive care initiatives. Treatments, procedures and costly, often physically uncomfortable, tests are needlessly repeated or ordered without sufficient reason. The result is that patient outcomes suffer leading to higher morbidity and mortality.

Moreover, clear trends present in the healthcare field militate toward a fully integrated data solution with point of service data updating by and among all health care providers and patients. Specifically, these trends include rising health care costs, an aging population, focus on preventive wellness care as opposed to reactive treatment care and of disease and portability of health care records. In contrast to these trends, currently in the United States, a patient's health care information is horribly fragmented in desktop computers, nonintegrated servers and hard drives as well as file cabinets and storage facilities. Most patient health care information is isolated with limited access available through pods or patient portals. The EMRs are non-integrated among a patient's health care providers.

The prior art discloses methods of creating and maintaining web based health care record repositories, some maintained by a service provider, with periodic updating of the EMRs. Marking of the data to associate it with a specific patient is disclosed in the prior art. Also, the prior art discloses using a human figure graphical user interface, among other user interfaces, to store and access the EMRs.

The present invention seeks to remedy the current fragmented state of patient medical information by implementing a patient-controlled, interactive database which provides a central repository for all patient health care information and family medical history stored and accessible in HL7/FHIR format. The method of the instant invention provides a fully integrated system including the patient and all of the patient's medical providers (from primary treating physicians to specialist physicians to diagnostic testing facilities to pharmacists) linked through an internet platform. Once access is permitted to a health care provider by the patient, the patient's EMRs are automatically updated to the patient's interactive database in HL7 format and categorized as a function of HL7 resource code within the patient's interactive database. This updating of the database takes place at the point of service and therefore is immediately available to all health care providers. These records are maintained on a web based system accessible through various graphical user interfaces on smartphone, tablet or computer.

Aside from the synergies and efficiencies described above, the purpose of the present invention is to provide the patient with at-will uninhibited access to the patient's own health records. This direct access to a patient's own medical records and information empowers the patient to take a more active role in his or her care and medical decisions.

Another purpose of the present invention is the creation of a large and rich database of patient medical information which can be sorted by any number of medically relevant characteristics.

### BRIEF SUMMARY OF INVENTION

A system and method of implementing a fully integrated, patient-controlled medical information and history database with immediate point of service updating of all of a patient's electronic medical records into HL7/FHIR format from any native format operating on an internet platform is disclosed in the present invention. The method disclosed provides for the creation of an internet based user interface with immediate point of service updating where patient medical information can be uploaded, sorted to a specific patient by patient identifier, categorized pursuant to HL7 resource code and accessed pursuant to the graphical user interface functionality of the system. The system and method further provides for a central database of patient medical information where potential patient drug interaction issues; potential insurance network acceptability issues and potential duplicative medical patient testing and medical procedures issues, among other issues, can be uncovered and reported. Additionally, the system and method results in the creation of a central database full of information on many patients. As such, this database can be searched as a function of any number of medically relevant characteristics.

The disclosed system and method is an improvement on the prior art in this field in that it provides for a patient-controlled, fully integrated, point of service updated internet platform database which automatically converts all EMRs into HL7/FHIR format. The EMRs are then categorized as a function of HL7 resource code within the patient's interactive database so that they are stored in such a way to provide easy access to the patient and all of the patient's health care providers. The system and method of the current invention results in the creation of a repository of all of the patient's medical information and history in one web based location accessible to all permitted health care providers and the patient directly via smartphone, tablet or PC. The current invention also creates a central repository of medical information which is searchable as a function of any medically relevant data parameters

### DRAWINGS

FIG. 1 is a diagram showing the general arrangement of the present system and method.

FIG. 2 is a diagram showing the patient/health care provider interaction of the present system and method.

FIG. 3 is a diagram showing the searching function of the present system and method.

FIG. 4 is a diagram of the patient health care provider encounter of the present system and method.

FIG. 5 is a diagram of the prescription medication insurance coverage function of the present system and method.

FIG. 6 is a diagram of the “Lock Box” feature of the present system and method.

FIG. 7 is a diagram of the “Private Zone” feature of the present system and method.

FIG. 8a is a diagram of the Process Flow Legend for FIGS. 8b through 8f.

FIG. 8b is a diagram of Sample Automation of Patient to Provider Activities of the present system and method.

FIG. 8c is a diagram of Sample Automation of Patient to Provider Activities of the present system and method.

FIG. 8d is a diagram of Sample Automation of Patient to Provider Activities of the present system and method.

FIG. 8e is a diagram of Sample Automation of Patient to Provider Activities of the present system and method.

FIG. 8f is a diagram of Sample Automation of Patient to Provider Activities of the present system and method.

FIG. 9 is a graphical user interface of the present system and method.

FIG. 10 is a graphical user interface of the present system and method.

FIG. 11 is a graphical user interface of the present system and method.

FIG. 12 is a graphical user interface of the present system and method.

FIG. 13 is a graphical user interface of the present system and method.

FIG. 14 is a graphical user interface of the present system and method.

FIG. 15 is a graphical user interface of the present system and method.

FIG. 16 is a graphical user interface of the present system and method.

FIG. 17 is a graphical user interface of the present system and method.

FIG. 18 is a graphical user interface of the present system and method.

FIG. 19 is a graphical user interface of the present system and method.

FIG. 20 is a graphical user interface of the present system and method.

FIG. 21 is a graphical user interface of the present system and method.

FIG. 22 is a graphical user interface of the present system and method.

FIG. 23 is a graphical user interface of the present system and method.

FIG. 24 is a diagram of the architecture of the present system and method.

FIG. 25 is a diagram of the architecture of the present system and method.

### DETAILED DESCRIPTION OF INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

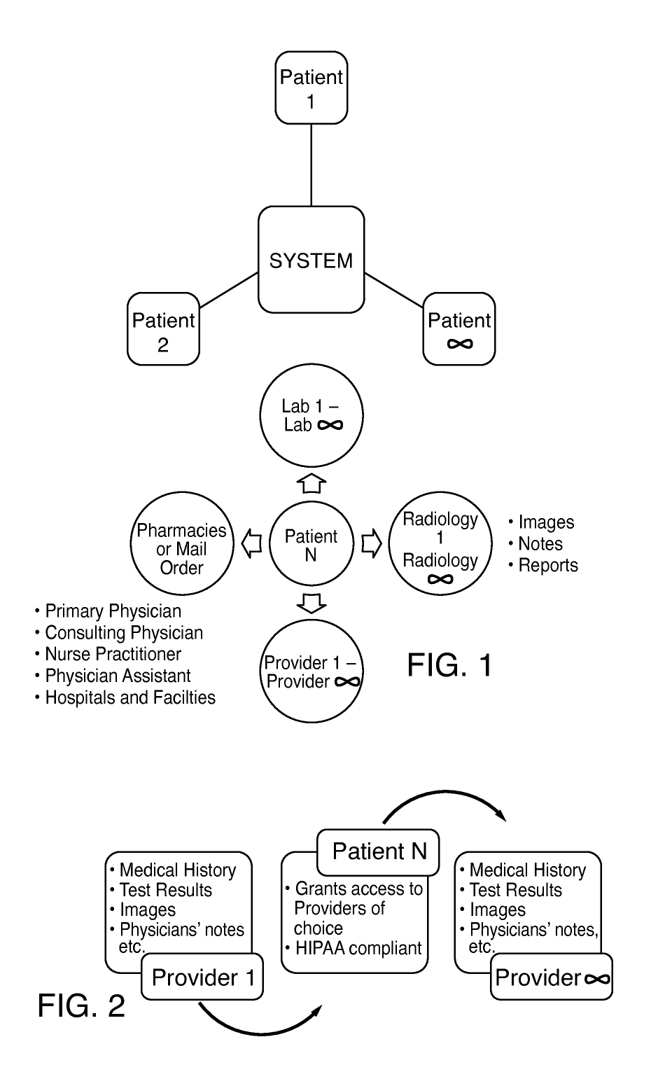

The system and method disclosed results in the creation of a fully operable complete electronic database of patients' medical information and history data. Each patient's medical information is stored as accessible data on the patient's medical records management system. FIG. 1 and FIG. 2. As such, the electronic medical records (EMRs) from various health care providers, transmitted into the patient's medical records management system database, are either received in Health Level-7 (HL7) or Fast Healthcare Interoperability Resources (FHIR) or the next generation resource protocol format or translated into one of these formats before being stored to a specific patient database and allocated within that database by resource code and ICD code.

HL7 is a set of international standards for transfer of clinical and administrative data between software applications used by various healthcare providers. HL7 specifies a number of flexible standards, graphical user interface, and methodologies by which various healthcare systems can communicate with each other. Such graphical user interface or data standards are a set of rules that allow information to be shared and processed in a uniform and consistent manner. HL7 messages use human-readable, non-XML encoding syntax based on segments (lines) and one character delimiters. Segments have composites (fields) separated by the composite delimiter.

FHIR is a draft standard describing data formats and elements and an application programming interface for exchanging EMRs. FHIR builds on the HL7 format but is considered easier to implement because of its use of web based application programming interfaces. FHIR facilitates interoperability between legacy health care systems, to make it easy to provide health care information to health care providers and individuals on a wide variety of devices from computers to tablets to cell phones. FHIR supports the integration of third party medical applications into the existing system. Additionally, FHIR provides an alternative to document-centric approaches by directly exposing discrete data elements as services.

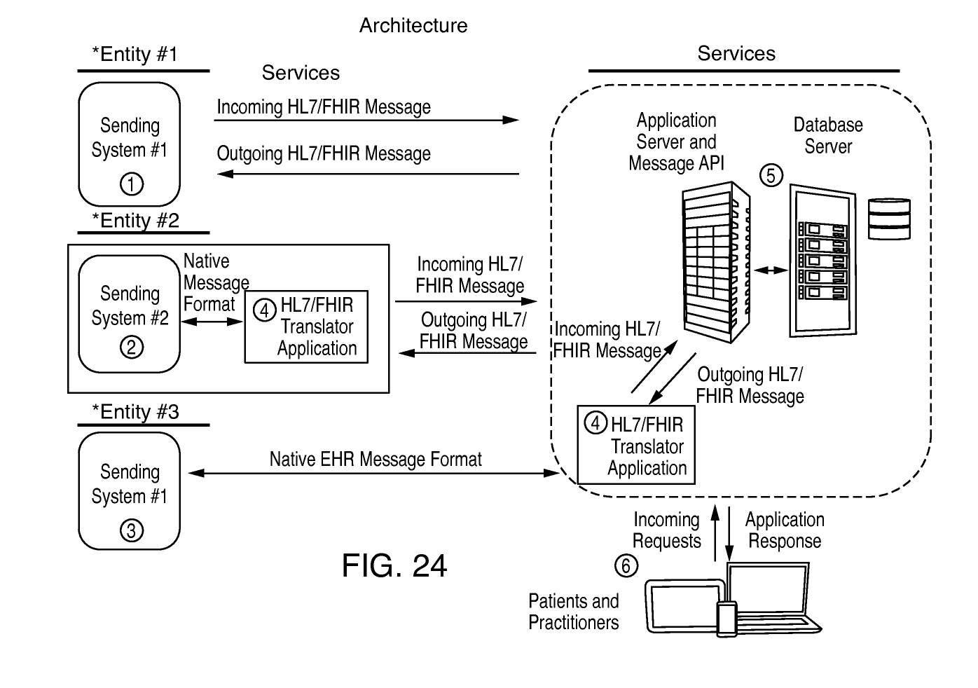

In one operational scenario of the disclosed method, a health care service provider employs an electronic medical record in HL7/FHIR format. So, here the medical treatment record is generated at the point of service with the patient. The medical treatment record is stored on the health care provider's electronic medical record server in HL7/FHIR format. The sending system generates a message that is automatically submitted to the medical records management system of the disclosed invention attaching the electronic medical record generated at the point of service with the patient. The message is received by the medical records management system database message processor via http. The message processer translates the incoming HL7/FHIR formatted message and in turn stores the information to the medical records management system database application server. From there the message is saved onto the database of the medical records management system as a medical record of a specific patient. The message processor unit sends an electronic message back to the sending system in HL7/FHIR format confirming receipt of the electronic medical record. FIG. 24.

In another scenario, a health care service provider employs an electronic medical record in something other than HL7/FHIR format but has a third party vendor providing middleware to translate the EMR to HL7/FHIR format. In this setting, the system sending to the medical records management system is the middleware translation application which is generating a HL7/FHIR formatted message that is submitted directly to the medical records management system database message processor via http. The message is processed as described above as is the HL7/FHIR formatted confirming receipt. FIG. 24.

In yet another scenario, a health care service provider employs an electronic medical record in something other than HL7/FHIR format and has no third party vendor providing middleware to translate the EMR to HL7/FHIR format. In this setting, the sending system generates a message that is automatically submitted to the medical records management system database of the disclosed method attaching the electronic medical record generated at the point of service with the patient. However, the message will be directed to the middleware integration engine residing on the medical records management system database message processor via http. The message processer then translates the message into HL7/FHIR format via the middleware software integration engine. From there, the electronic medical record—now in HL7/FHIR format—is associated with the particular patient and the EMR is sorted per ICD code to reside at a specific location in the medical records management system database. The message processor unit sends an electronic message back to the sending system. FIG. 24.

In each of above scenarios, the medical records management system server will host both the message processor and FHIR application platform interface. The role of the message processor is to listen for and process inbound messages, verify format, recognize FHIR formatted messages and pass these through to the medical records management system database. Other messages, not in FHIR format, are directed to the middleware software integration engine where they are translated into FHIR format and stored onto the database of the medical records management system as an EMR of a specific patient. FIG. 24.

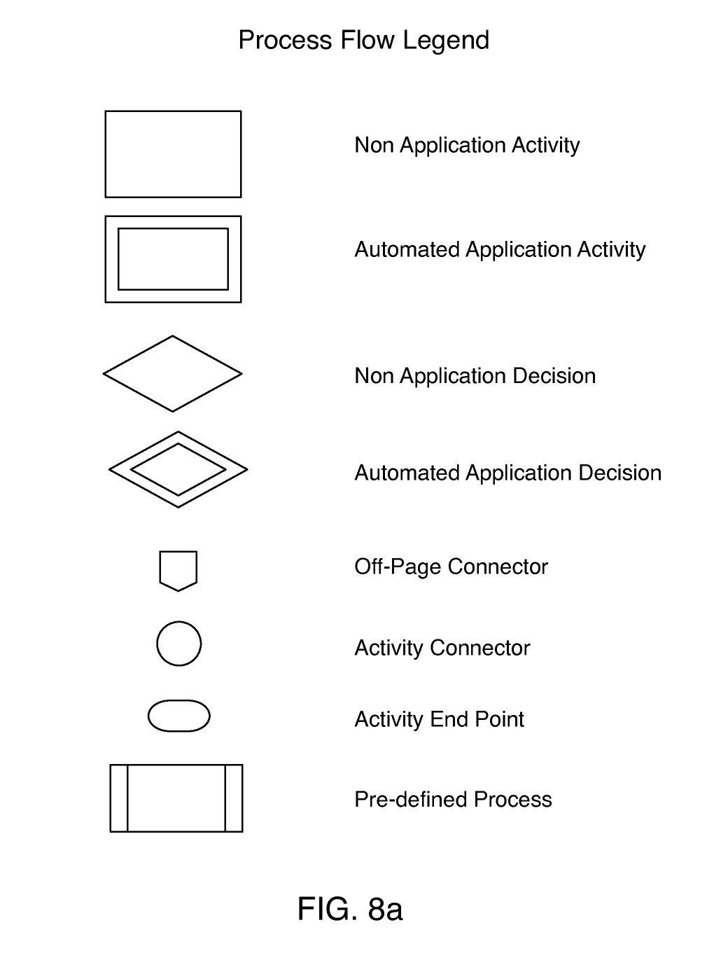

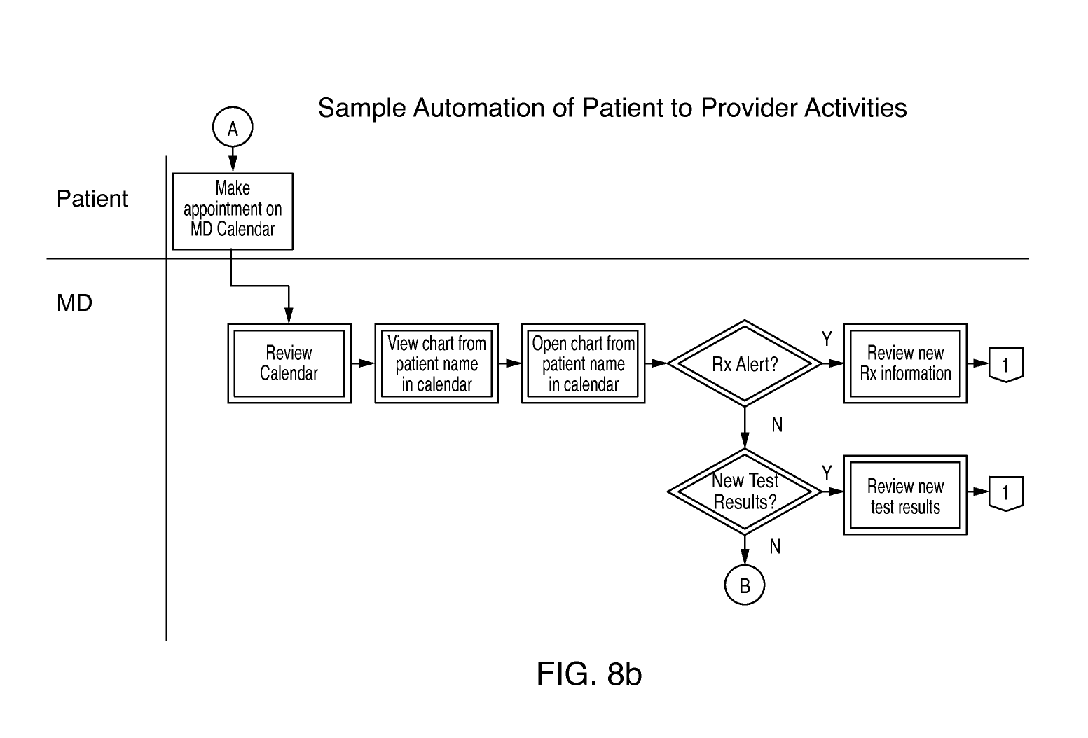

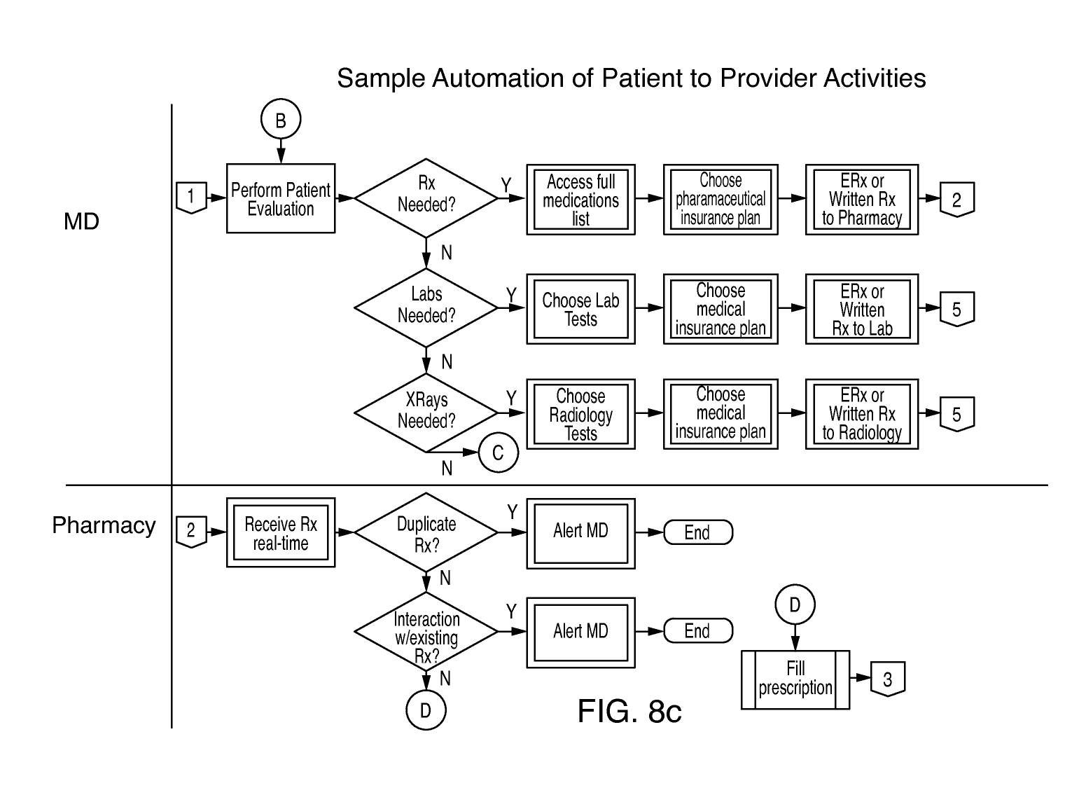

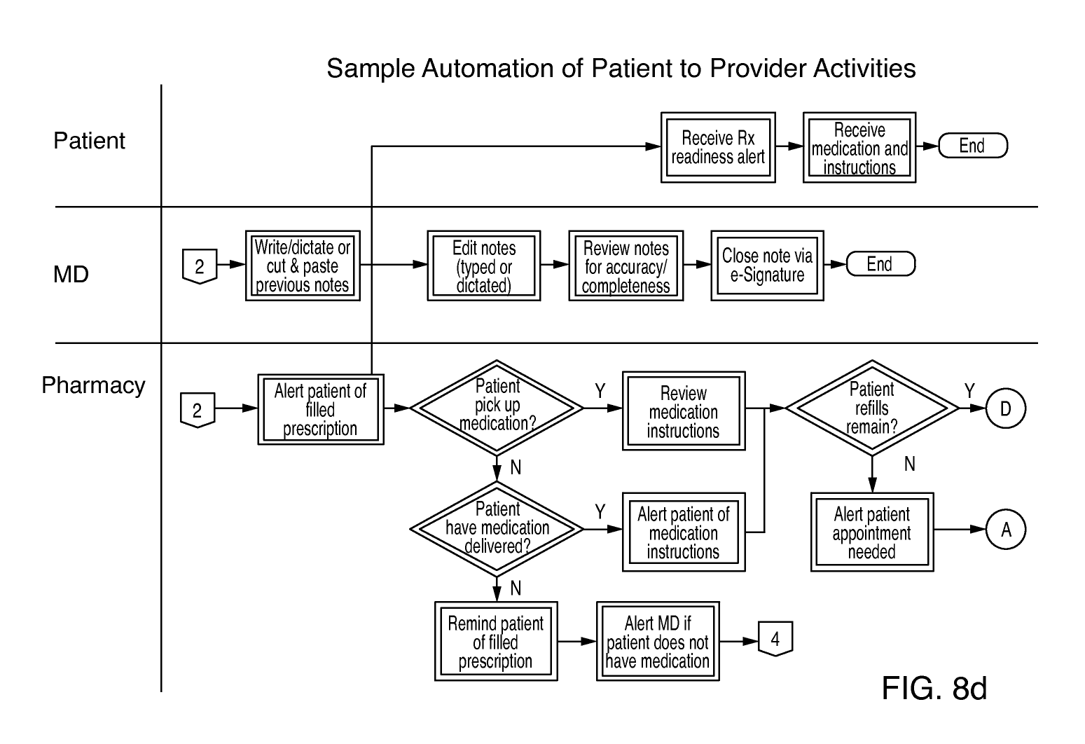

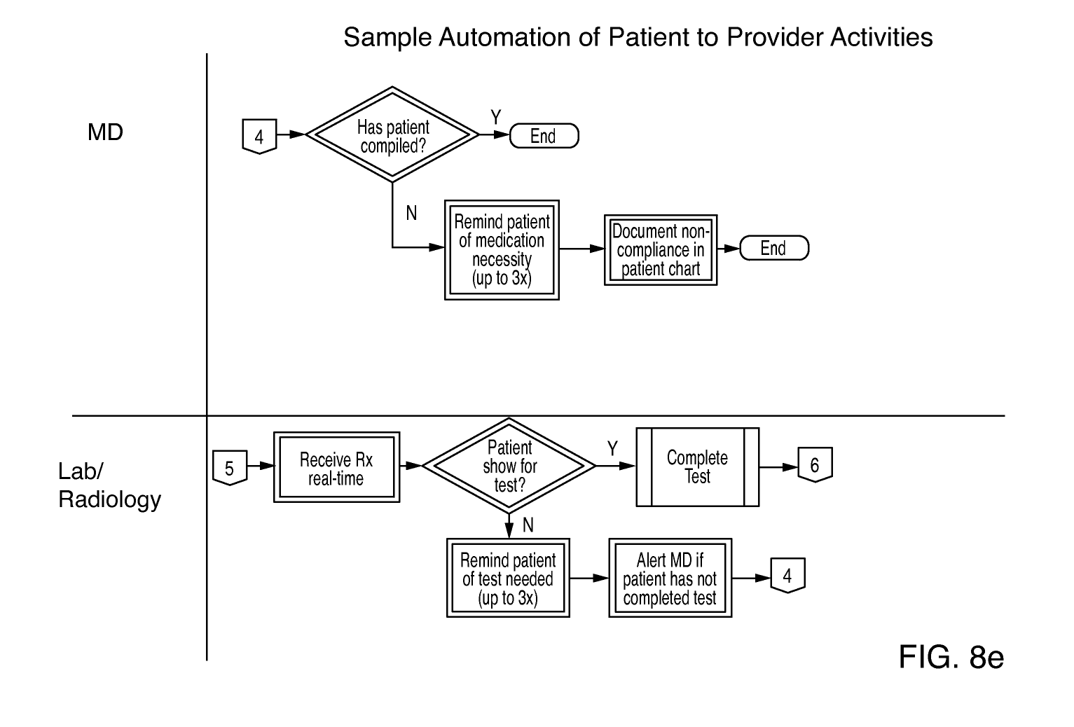

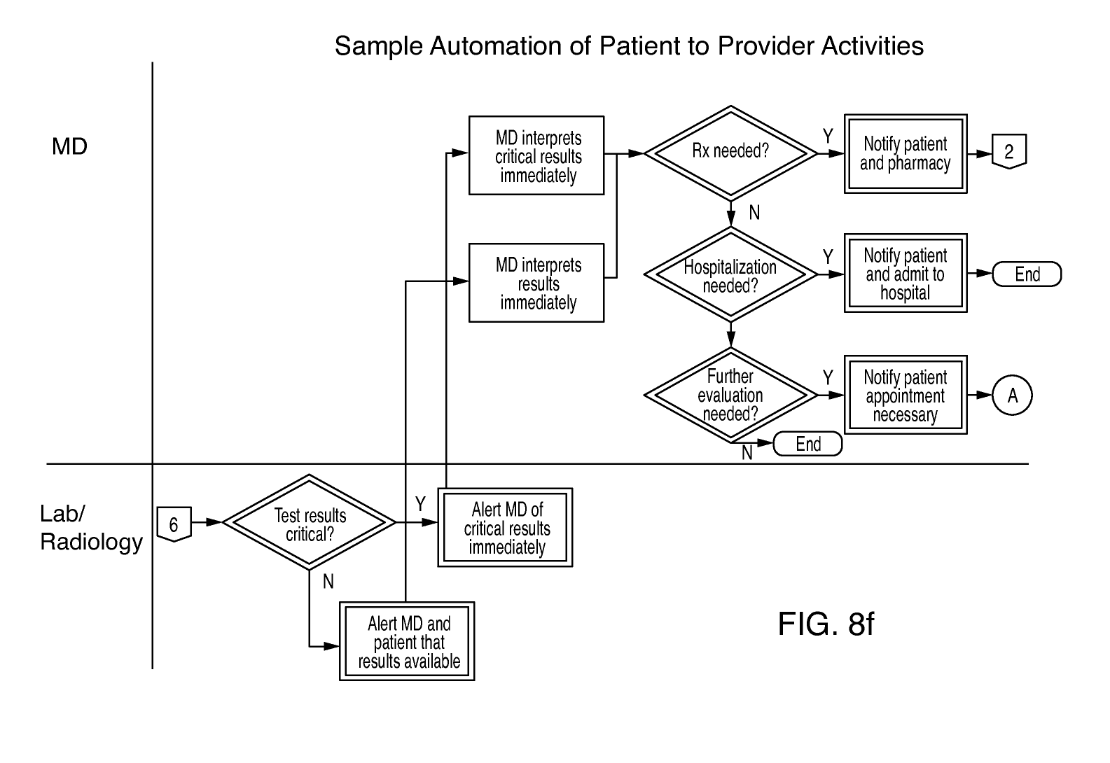

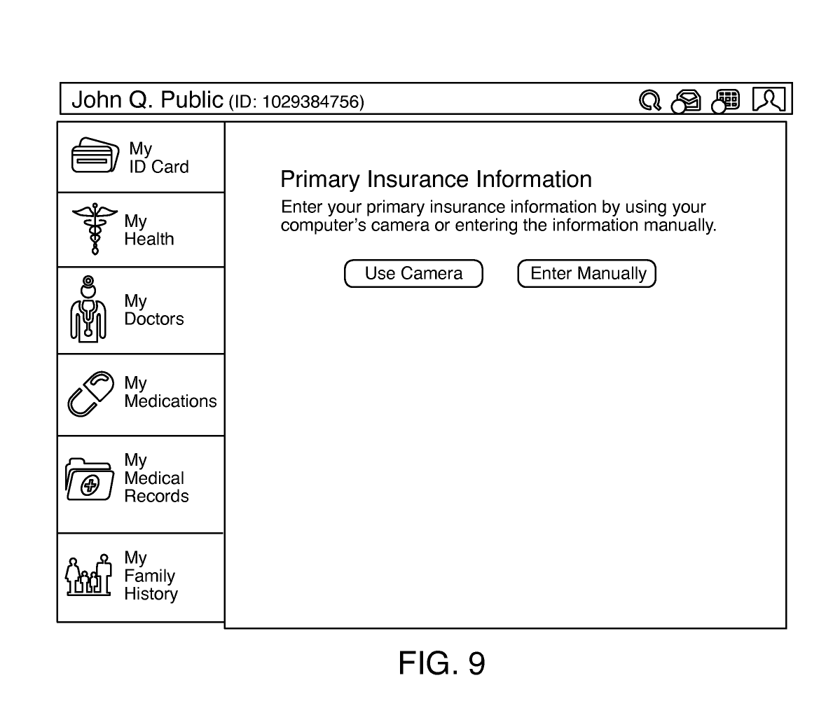

The process work flow that patients encounter with interacting with the medical records management system is described in FIG. 8a through FIG. 8f. The flow initiates with the patient's creation of an appointment with the health care provider properly slotted into the schedule of the health care provider. The health care provider's staff opens the appointment and signs on to view the patient chart, confirming proper patient identifiers. Several automated alerts are revealed, for example, prescription alert and test results. If a new prescription is needed, a review process begins. Similarly, if a new test is required, a review process begins. FIG. 8b.

The health care provider then begins patient evaluation and examination. A decision is made regarding the need for prescription medications, laboratory screens and tests. An automated process accesses lists of patient insurance plan-appropriate facilities to fulfill these needs. The medical records management system checks for potential adverse drug interactions and allergies. The medical records management system prompts for an electronic prescription or written prescription. The medical records management system monitors the filling of prescription or completion of diagnostic testing. Alerts are generated notifying both the health care provider and patient if medical directions are not followed. FIG. 8c, FIG. 8d and FIG. 8e.

The health care provider documents the medical care rendered in a note, inclusive of severity and time spent. If the note is generated within the medical records management system, rather than being pulled form an external EMR, then the note is reviewed, electronically signed and closed to further editing. At this point, the note resides on the medical records management system database and may not be destroyed.

At time of visit or upon review of test results, a decision tree prompts the need for prescription medication, further testing, future appointments, hospitalization, referrals or other treatment directive. This then feeds back into the original treatment tree and begins the process again. If no further treatment is needed, the tree ends designating completion of care. FIG. 8f.

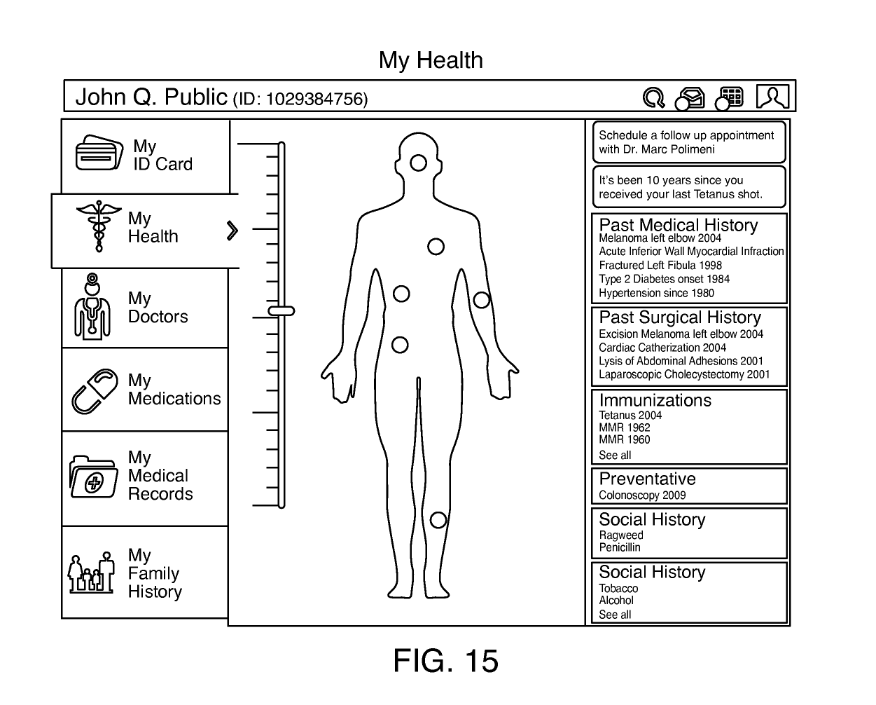

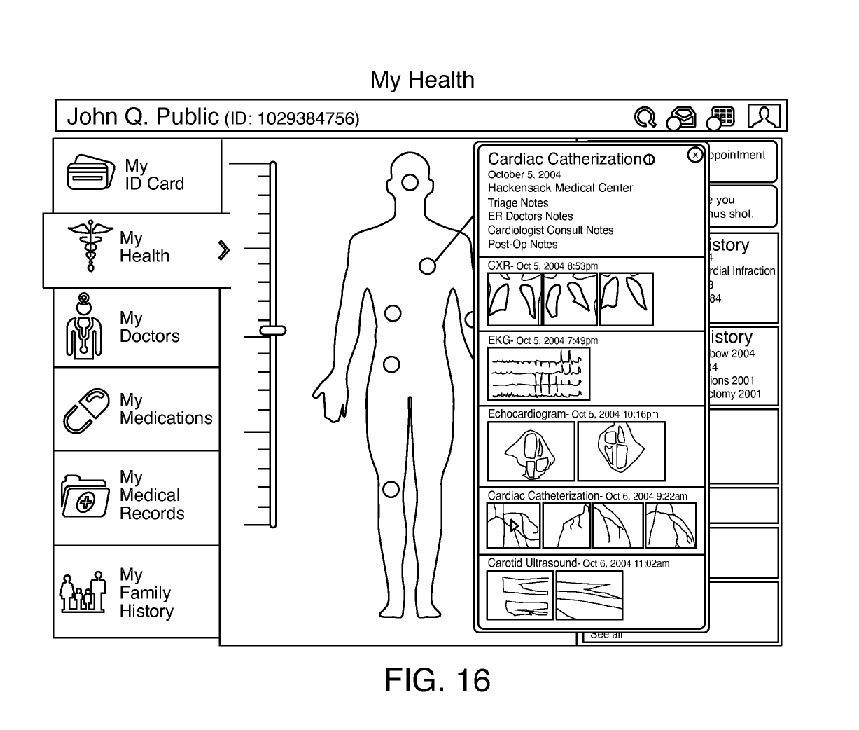

At the log-in stage, the user (e.g., patient, health care provider, insurance representative) provides credentials to the medical records management system to establish the user's role and therefore define the user's access. If the user is a patient (user patient), the patient identification value is returned in encrypted form. The patient selects the MyHealth option (FIG. 15 and FIG. 16) from the user interface menu. This initiates a request from the medical records management system database for the user patient's medical history.

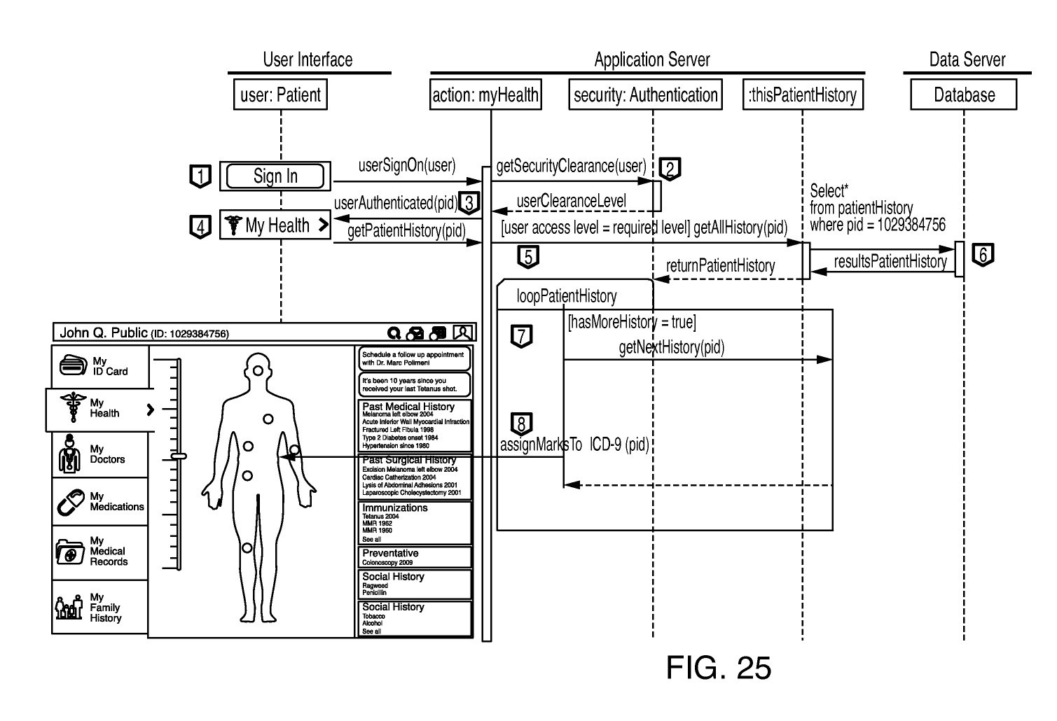

The ability to associate a user patient of the application to one or more roles or privileges is designed into the system architecture, supported by the authentication service, and stored in the database. As user patients are on-boarded, a unique user ID/patient ID is created by the Authentication Service and stored in the database as part of the user patient's credentials. Additionally, a user patient may also delegate access to his/her records, limiting the scope of access to information pertaining to a particular medical record. This is accomplished by creating and storing a data relationship between the user patient, health care provider and user patient records. In addition, the user patient can designate records private (the default). The user patient can specify this privacy at the high level resource, all observation records, or at a specific instance of an observation. This is accomplished by storing an indicator in the database and limiting the scope of all their records. FIG. 25.

Once the patient's log-in information has been authenticated, the application programming interface maps the request to a database query and passes this request to the database server. The medical records management system database server queries the appropriate database objects and returns a result set containing the user patient history and necessary information to map the ICD codes to the human like anatomical figure appearing on the user interface screen. FIGS. 15, 16 and FIG. 25.

The user patient's medical information and history program loops through the patient history server and constructs the grid which will display the patient's medical history. The application then accesses the application programming interface of the human like anatomical figure to mark or pin point the portion of the human like anatomical figure that corresponds to the data present in the patient's medical history. FIG. 16 and FIG. 25. The functionality and capability to interact with the images of the human body is made possible through an application programming interface such as but not limited to Bio Digital Human. The application programming interface is accessed by forming a RESTful Web service call via an http://request in which case the application programming interface returns the image or movement of the image, indicated by the request, to the invoking application. FIG. 25.

The user patient is presented with a login form and provides credentials for the client application to authenticate and determine the user's role. In one embodiment, the application authorization service returns a token that identifies the user as a patient (user patient) and also provides the user patient's identification. From this point on, the user patient identification is available to the processes that make up the application. FIG. 25.

When the user patient selects the MyHealth menu option, an anatomically correct view of a human body graphical user interface is presented with the user patient's medical records presented by marks or pins in the locations on the body. FIG. 15. By selecting the MyHealth menu item, the client application initiates a request to the application server and passes the patient identification and a code in the URL to the application server, that specifies that this is a request to get the user patient's history. The application server receives the request and forms a query that specifies the name of the database resource that contains observations and procedures. The user patient's identification is inserted as a filtering criterion to limit the data returned by the database server to only those records that pertain to the authenticated user patient. FIG. 25.

Also, based on this query, the database server returns the ICD code, which is stored in the database as part of the observations and procedures records for a specific medical record. The database server contains an object which operates to map the ICD code to the anatomically correct human figure graphical user interface body location for a particular medical record. The database server then looks up the location on the human body graphical user interface which relates to the ICD for the specific medical record returned from the query. FIG. 25.

Once the query is formed by the application server, the application server connects to the database server and sends the database server the query. The database server processes the query and returns a dataset to the application server containing the user patient's identification, a text description of the procedure, the ICD code for the procedure, the date of the procedure and the location on the human body relevant to the procedure. The data returned to the application server is processed as an array. The application server loops through the list of the user patient's procedures in the array and forms pins or marks on the image of the human body graphical user interface, based on the body image location coordinates, relating to the previously mapped ICD codes. FIG. 25.

Once the application server processing is complete, the client application receives the human body image graphical user interface, which is presented by the browser or mobile platform. Encapsulated in the html data along with the pins and returned to the client application, is the text descriptions associated with the user patient's procedure. FIG. 16. In this way, when the user patient or health care provider hovers or clicks on the pin with an interface device like a mouse, a pop up displays presents more details about that specific procedure associated with this user patient relative to the medical records associated with the pin marker on the anatomically correct human form graphical user interface. FIG. 15, FIG. 16 and FIG. 25.

The following presents an example of one of many common scenarios in which the health care provider's EMR system is HL7/FHIR compatible and the user patient information is pushed to the medical records management system of the present invention. A user patient visits his/his physician for a medical examination. Upon conclusion of the examination, the physician records the observation of the user patient's examination into an EMR application local to that physician's office. The observation is now part of the patient's medical records and resides in the EMR, which is external to the medical records management system of the present invention. In this particular use example, the EMR application in the physician's office has the capability to send and receive data in HL7/FHIR format. FIG. 24.

The physician's internal EMR system (the sending system) was previously registered with the medical records and management system of the present invention through the Authorization Service. This registration provided the sending system a secure token for future use in connecting to the medical records and management system. This is all contained in the authentication and authorization pattern as part of OAUTH2.0/OpenId, in which a client application (sending system) can present a security token as part of an application programming interface call in order to authenticate itself and thereby enable an authorization decision by the application programming interface hosting the resources—the current invention. FIG. 24.

The sending system generates a secure encrypted message, which, in segments, contains the following information: (i) the destination address of the target authentication service, (ii) the secure token, identifying the sender, (iii) further information identifying the sending application (web address) and (iv) the remainder of the message in FHIR format containing the user patient's identifying information and the medical record. FIG. 24.

The secured encrypted message is sent over the internet via http directly to the medical records and management system authentication service which receives the encrypted security token, authenticates and authorizes this particular EMR entity (physician's office in this case), and then redirects the message to the application server. If the token is not recognized by the Authentication Service, an http response to the sending application will indicate that the request is denied.

The application server receives the inbound message and parses the necessary header information and the user patient's medical record into a usable data pattern as described herein. The user patient's information is used by the message processor to form a database query. Once the query is formed by the message processor, the application server connects to the database server and sends the database server the query. In this example, the application server has translated the RESTful PUT request into a database insert query. The database server will receive the query, which contains various pieces of information to identify the user patient (e.g., address, driver's license, Social Security Number, passport), and will verify the existence of that user patient in the applications database of user patients. If the results of the verification database query provide that the user patient is not found, then an additional database process generates a new, unique, patient identifier (PID), and inserts the user patient information into the FHIR pattern for a patient resource, storing it in the database. Subsequently, the database query will insert and store the user patient's medical record into the appropriate FHIR resource pattern, using the PID—in this case, an observation resource. FIG. 24 and FIG. 25.

The following presents an example of one of many common scenarios in which the health care provider's EMR system is HL7/FHIR compatible and the user patient information is pulled by the medical records management present system. A user patient visits his/his physician for a medical examination. Upon conclusion of the examination, the physician records the observation of the user patient's examination into an EMR application local to that physician's office. The observation is now part of the patient's medical records and resides in the EMR, which is external to the medical records management system of the present invention. In this particular use example, the EMR application in the physician's office has the capability to send and receive data in HL7/FHIR format. FIG. 25.

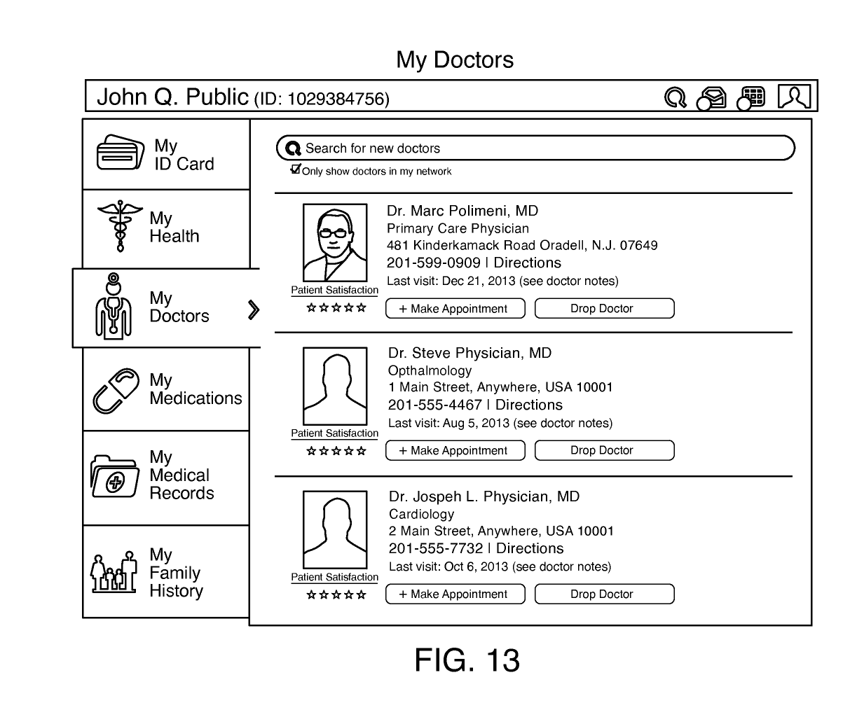

In this scenario, the user patient left the physician's office several days ago and now wants to include and view the physician's observations through the medical records and management system of the present invention. The user patient signs into the medical records and management system on a computer, tablet or smartphone (the client application) and is authenticated and the user patient's PID is available to the client application. The user patient navigates to the health care provider view. The client application sends a request to the application server in the form of an http message, passing it the PID and a request for a list of health care providers. The application server receives the request and parses the PID and recognizes the request for practitioner resources. FIG. 13. The application server forms a database query that requests the health care provider information stored in the practitioner resource in the database, filtering the query to the current PID.

Once the query is formed, the application server connects to the database server and sends the database server the query. The database server processes the query and returns a data result set containing the health care provider's and web address. The health care provider data for this user patient is returned to the client application and presented in a user interface list. The user patient then selects the name of the physician they recently visited and then selects a user interface button element embedded next to the physician's information, which initiates a request to the physician's EMR to retrieve medical records.

The client application sends a request to the application server in the form of an http message, passing it the PH) and the health care provider's information. The application server receives and parses the request, forming a database query, requesting user patient details. The database server returns the requested user patient information to the application server, where the application server forms an http request containing the web address of the EMRs application server.

The sending system, in this case the medical records management system of the present invention, has previously registered with the physician's EMRs authorization service which provided a secure token for future use in connecting. This is all contained in the Authentication and Authorization pattern as part of OAUTH2.0/OpenId process, in which a client application can present a security token as part of an application programming interface call in order to authenticate itself on behalf of the patient and thereby enable an authorization decision by the application programming interface hosting the resources—the EMR application.

The physician's EMR system generates a secure encrypted message, which, in segments, contains the following information: (i) the destination address of the target authentication service, (ii) the secure token, identifying the sender, (iii) further information identifying the sending application (web address) and (iv) and the remainder of the message in FHIR format containing the user patient's identifying information and the medical record.

The message is sent over the internet via http directly to the medical records and management system's authentication service. The medical records and management system receives the encrypted security, token authenticates and authorizes this particular EMR entity, and then redirects the message to the application server. If the token is not recognized by the Authentication Service, an http response to the sending application will indicate that the request is denied.

The application server receives the inbound message and parses the necessary header information and the user patient's medical record into a usable data pattern. The user patient's information is used by the message processor to form a database query. Once the query is formed by the message processor, the application server connects to the database server and sends the database server the query. In this example, the application server has translated the RESTful PUT request into a database insert query. The database server will receive the query, which contains various pieces of information to identify the user patient (e.g., address, driver's license, Social Security Number, passport), and will verify the existence of that user patient in the applications database of user patients. If the results of the verification database query provide that the user patient is not found, then an additional database process generates a new, unique PID.

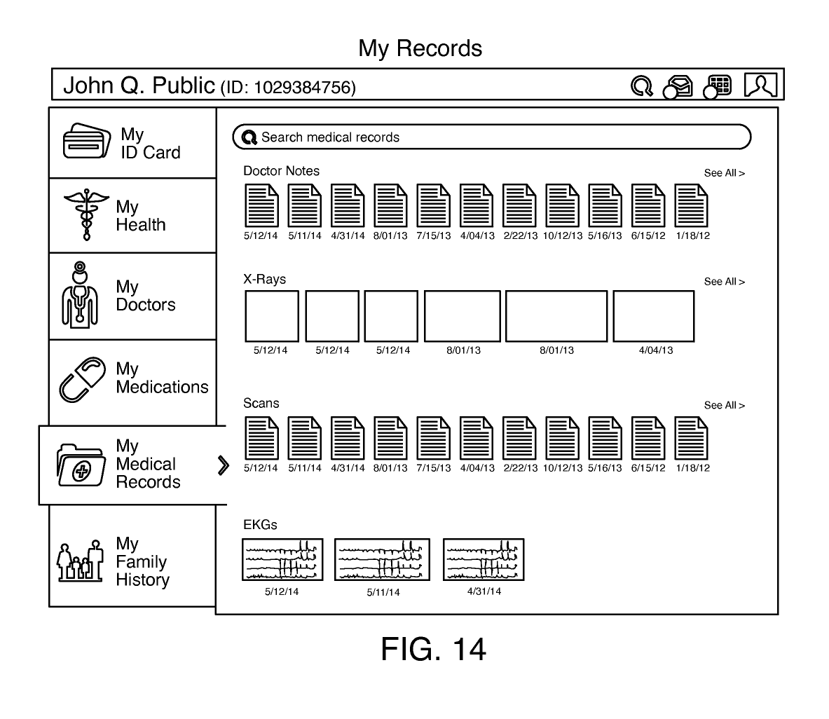

Subsequently, the database query will insert and store the user patient's medical record into the appropriate FHIR resource pattern, using the PID. The medical records and management system application server will create a notification event for the user patient, indicating that the medical record(s) have been received. The user patient can now interface with the medical records and management system client application and retrieve their information. FIGS. 14, 15 and 16.

As a service to third party entities, the client application will provide a user interface to support, user defined queries of general user patient medical data. The application server will support the interface between the client application and the database server.

In one embodiment of the present invention, the user interface will support a request for inclusion criteria for general user patient data for a particular geographic region. The user researcher is authenticated in a similar manner as described for a user patient. This is all contained in the authentication and authorization pattern as part of OAUTH2.0/OpenId process, in which a client application can present a security token as part of an application programming interface call in order to authenticate itself on behalf of the patient and thereby enable an authorization decision by the application programming interface hosting the resources—the medical records management system application.

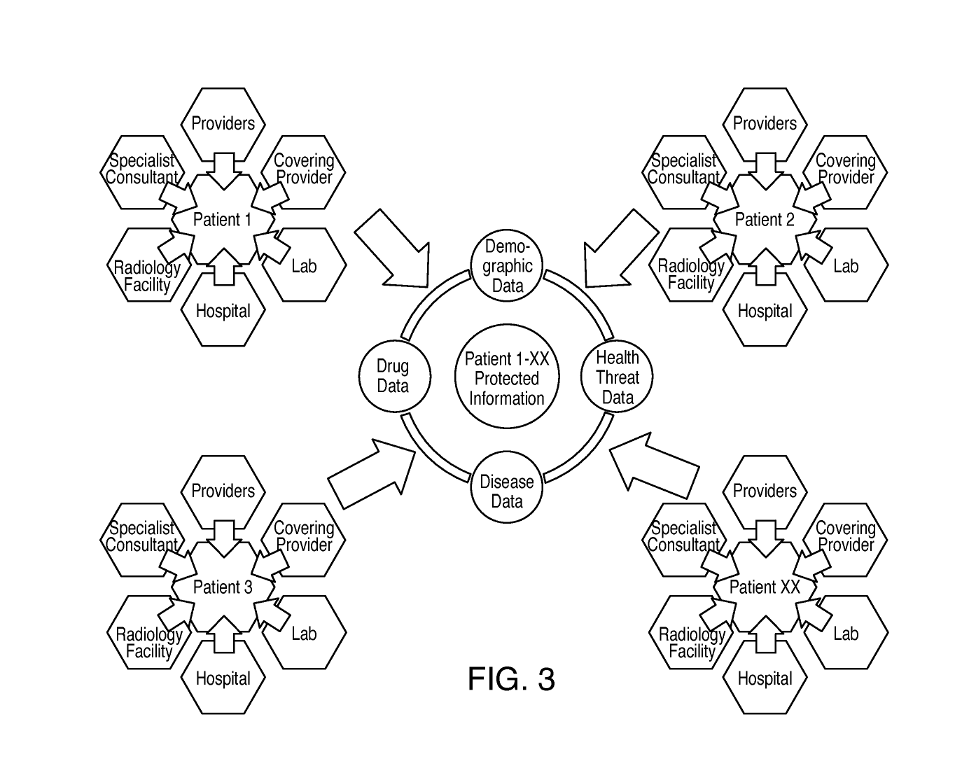

The user researcher has access to the user interface that supports the queries and can provide search criteria to data mine the medical information in the medical records management system. Upon completion of entering the search criteria, the user submits a query through the user interface. The client application forms a RESTful application programming interface call to the application server in the form of an http message containing the selection criteria. The application server web server receives the http message and parses it into data variables. The application server then forms a database procedure call using the selection criteria variables as parameters to the procedure. The application server then connects to the database server and sends the query statements to the database server for processing. FIG. 3.

The procedure statements sent to the server for processing were predefined, so that only general patient level data is requested and returned. For example, gender, age, geographic region together with the analytical information such as, diagnostic codes or blood pressure measurements. Since, user patient identifying information such as name, address and social security numbers is not included in the query, it will not be returned in the result set and therefore the return on the search will not identify user patients identified with the search results. FIG. 3.

The database server returns the data resulting from the query to the application server. The application server formats the data into format of the user's choice provided by the user interface (i.e., xls, csv or txt). The application server returns the icon of the file image to the client authorization, where the user can click a user interface element to download the file.

All health care providers are authenticated in a similar manner as in other claims referenced in the patent. This is all contained in the authentication and authorization pattern as part of OAUTH2.0/OpenId process, in which a client application can present a security token as part of an application programming interface call in order to authenticate itself on behalf of the user patient and thereby enable an authorization decision by the application programming interface hosting the resources—the medical records management system application or third party application.

The user patient, as part of the on-boarding process, provides Health Insurance Portability and Accountability Act (HIPAA) information via the client application user interface, which passes the information to the application server, which formats and communicates with the database server and stores the HIPAA form information into the database. Authorization to the user patient's records is provided to health care providers when access is granted to these providers through the client application user interface. FIG. 8d. When a health care provider is authorized by the user patient, that health care provider is automatically sent a HIPAA authorization allowing that provider to transmit EMRs to the medical records and management system.

The application will store, as part of its database server, the contents of a publicly available drug database known as The Physicians' Desk Reference (PDR). The drug database contains information pertaining to all prescription and all non-prescription drugs.

In one embodiment of the present invention, the application will use the drug database as way to identify potential adverse reactions to medication being prescribed, and alert the necessary parties. FIG. 8c. The physician prescribes medication for the user patient and enters the information into the physician's EMR system, which is external to the medical records and management system. The user patient's medical record containing the prescription information is sent to the medical records and management system as described earlier. FIGS. 8b, 8c and 8e.

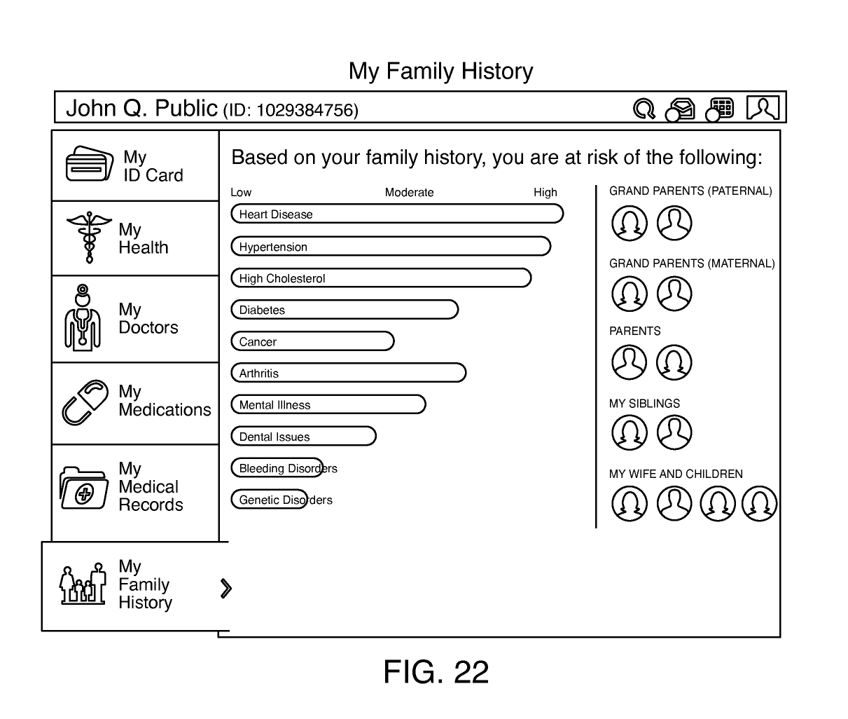

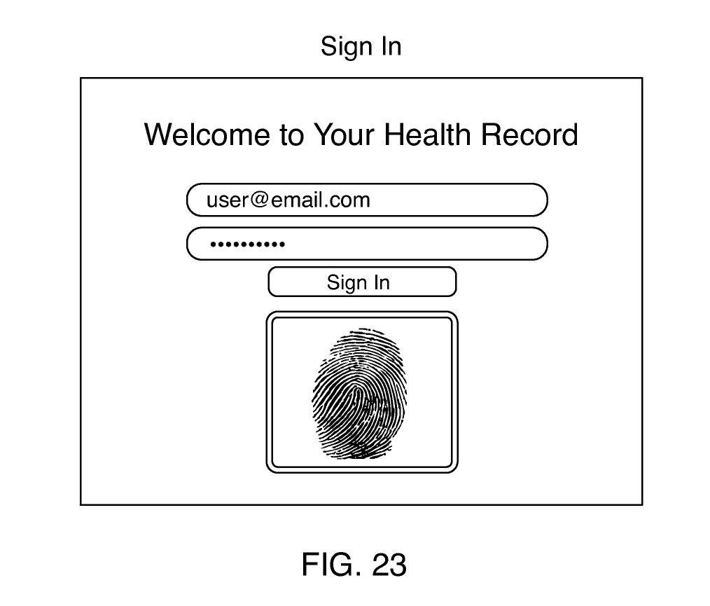

Upon successful receipt and the successful storage of the patient's record of medications, the application server recognizes that this event has occurred and triggers a secondary process on the server. The secondary process looks up the medication in the drug database containing the PDR data for the recent prescription and stored into the database. When a match is found, additional information in the PDR identifies cautionary and advisory data regarding this medication. FIG. 22 and FIG. 24.

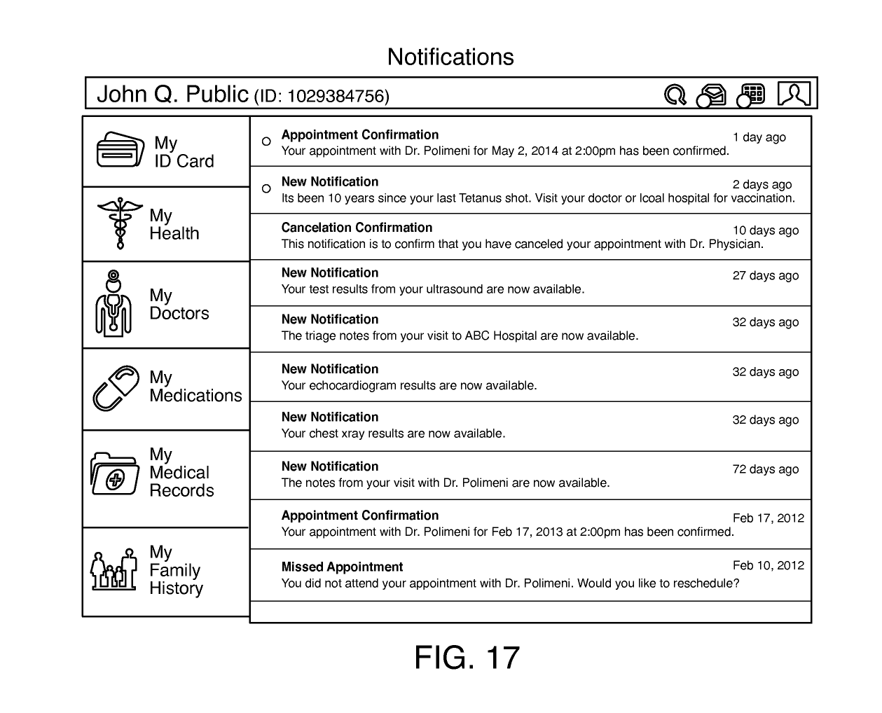

The process continues and additionally searches the database server for a match on the substance in order to alert the user patient of a potential adverse or allergic reaction. FIG. 8c. Upon completion of these searches, if a potential adverse reaction is found, a notification is created and posted in the user patient's notification list. FIG. 17. An alert is sent via email or text to all parties, such as the user patient, the user patient's physician and the user patient's pharmacy. Additionally, the notification is visible on the application user interface.

Additionally, the medical records management system will access the user patient's primary or secondary insurance carrier's database of prescription drugs, via the insurance provider's open RESTful application programming interface. This allows the application server to retrieve a list of “in-plan” prescription medications, via http, that correspond to the user patient's insurance plan, as defined by their insurance information contained in the patient's insurance plan. FIG. 5 and FIG. 9.

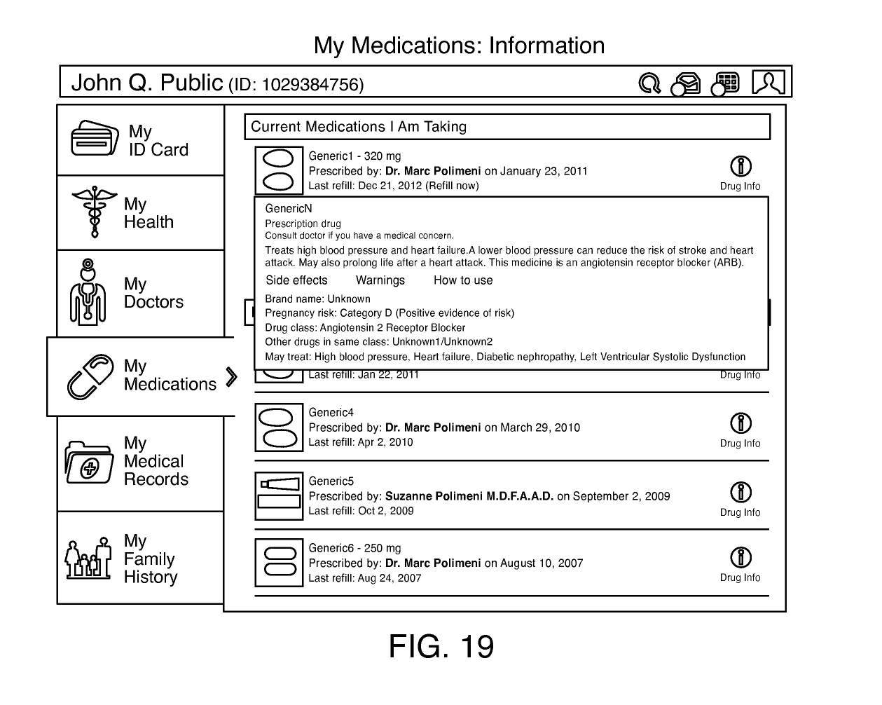

The application server will look-up the list of the user patient's insurance coverage information and match to the list of “in-plan” prescription medications, in order to determine if the medication is covered by the user patient's plan. FIG. 5 and FIG. 9. Upon completion of these searches, a notification is created and posted in the user patient's Notification area. FIG. 17. An alert is sent via email or text to the user patient and physician who prescribed the medication and is visible on the application user interface. FIG. 19.

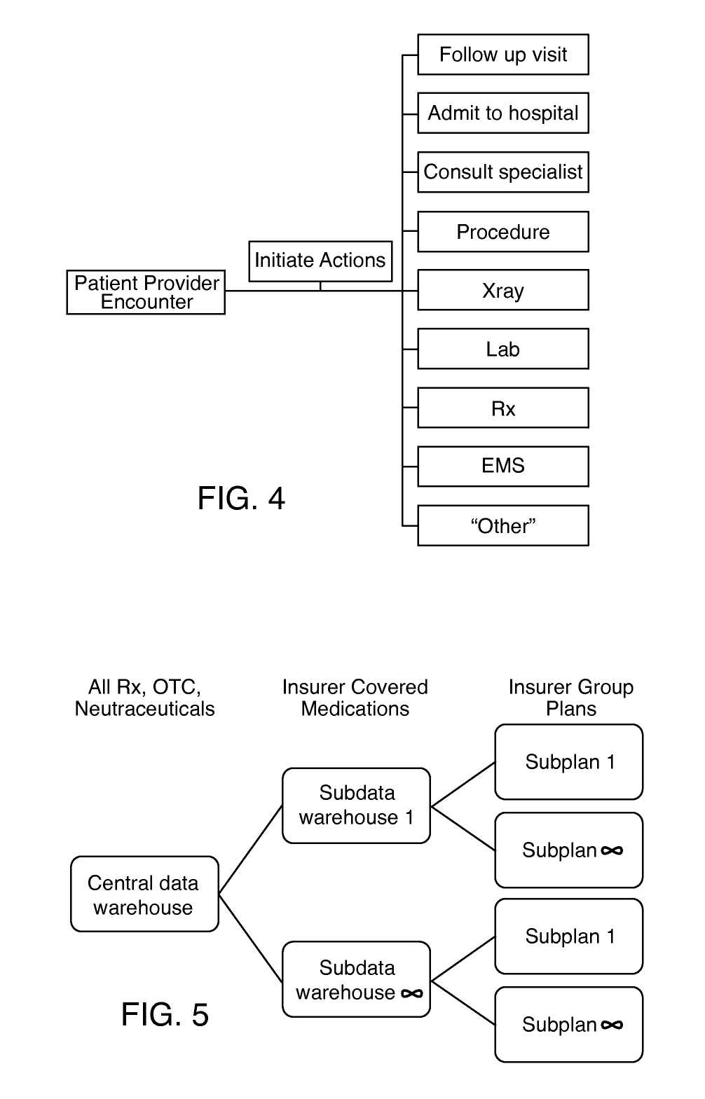

The present invention will access the user patient's primary or secondary insurance carrier's database of providers via the insurance provider's open RESTful application programming interface. This allows the application server to retrieve a list of “in-network” health care providers, via http, that correspond to the user patient's insurance plan, as defined by the user patient's insurance information contained in the user patient's insurance information. FIG. 4 and FIG. 9.

The list of in-network providers is utilized in the process of the user patient selecting a new provider. In addition, a background process, running on the application server, will look-up the list of each user patient's health care providers and match to the list of in-network health care providers, in order to determine if user patient's health care provider is still in-network. FIG. 4. Upon completion of these searches, a notification is created and posted to the user patient's notification area. FIG. 17. An alert is sent via email or text to the user patient and is visible on the application user interface.

In another embodiment of the present invention, a physician authorized by a user patient prescribes a test or procedure for the user patient and enters the information into the physician's EMR, which is external to the medical records management system. The user patient's medical record containing the prescribed test or procedure is sent to the medical records and management system as described earlier. FIG. 4. Upon successful receipt and the successful storage of the patient's health and medical records area (FIGS. 14, 15, 16 and FIG. 17), the application server recognizes that this event has occurred and triggers a secondary process on the server.

The secondary process looks up the test or procedure in the history of procedures contained in the user patient's health and medical records area. FIGS. 14, 15 and FIG. 16. When a match is found, a notification is created and posted in the user patient's notifications area. An alert is sent via email or text to the user patient and the physician prescribing the test or procedure, as a potential duplicate procedure. Additionally, the notification is visible on the application user interface.

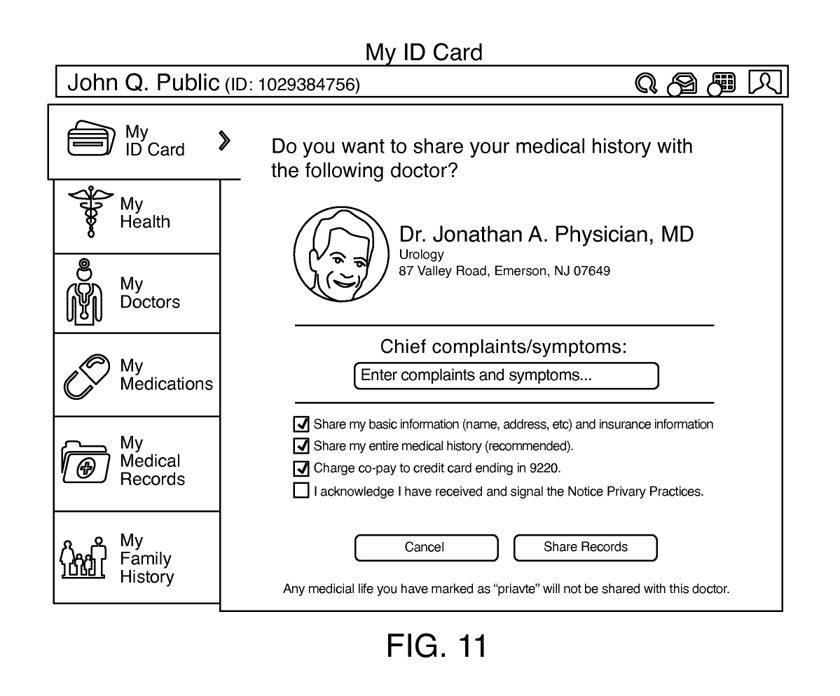

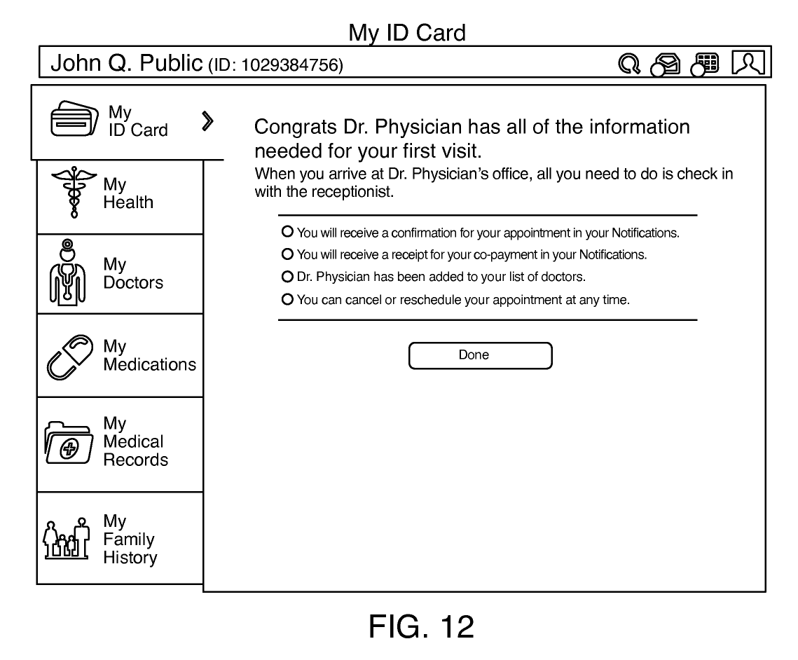

The Graphical User Interface (GUI) components of the system display the patient's medical history on the human like anatomical figure with the ICD identified on the areas of the gross anatomy of the patient at the present time. FIGS. 11, 12 and FIG. 13. In addition to displaying the patient's medical history on the human like anatomical figure, the patient user will also be able to zoom into any anatomical part or feature of the human like form. By zooming in, the figure will display, in true anatomical form, from the exterior level of skin to the microscopic view of human structures and components, all visual and biological functions and features associated with the anatomy searched or zoomed in upon. A GUI component in the form of a slide bar or similar functioning GUI allows the user the scroll through the patient's medical history by age of the patient. FIG. 11 and FIG. 12. When this is done, the human like anatomical figure will change to reflect the selected patient's age and update the patient's medical history for the selected time to appear on the figure.

The following provides examples of how the system operates in certain common functionality modes. Initially a new patient user will access the access the site and by a series of prompts to provide information such as: First Name, Middle Name, Last Name, Gender, Date of Birth, Social Security Number, Billing Address, Shipping Address, Marital Status, Email Address, Phone Number, Employer Name, Employer Address, Employer Phone

The patient user will also be prompted to provide all primary health insurance information, if any, including the name of the insurance company, group number and ID number along with any other pertinent information. The patient user will also be prompted to provide any secondary or supplemental healthcare insurance and coverage information along with all other family members, and their respective information, who are also under the relevant health care insurance plan or plans.

The Insurance Information area allows the user to view and manage their health insurance plans. FIG. 9. The application can support multiple insurance plans. The patient user's insurance information can be added to the application in 2 ways—by manually entering the information or via the user interface built-in camera on the user's device or computer.

If the patient user chooses to enter the information manually, they need to complete the following steps: select their insurance company from the displayed company names. By default, the top insurance companies in the user's zip code will be shown. If the user does not see their insurance company listed, they can click/tap a link to show all available insurance companies; enter their Group number and ID number and enter their policyholder's social security number.

If the patient user has successfully entered and saved their insurance information, the screen will display this information under the heading “Primary Insurance Information.” FIG. 9. Under this heading, the insurance card will be displayed. The card will contain the insurance company logo, Group number, and ID number. Also displayed will be 2 links: “View Plan Details” and “Edit Card Info.”

The patient user can also choose to enter their insurance information via the user interface built-in camera on their computer or device. This is done by holding the card in front of the camera on their computer or device. The application via the camera will be looking to identify three components:
1. Insurance company name, based on their logo
2. The Group number
3. The ID number

Once the patient user clicks/taps the “Done” button and, if the camera has successfully captured their insurance information, the screen will display this information under the heading “Primary Insurance Information.” Under this heading, the insurance card will be displayed. The card will also contain the insurance company logo, Group number, and ID number. Also displayed will be 2 links: “View Plan Details” and “Edit Card Info.”

When the patient user clicks/taps the “View Plan Details” link, they are presented with a screen that displays the following:
Image of the insurance card, containing company logo, Group number, and ID number
Dates of coverage
Policyholder's first and last name
Remaining deductible amount, shown in localized currency format. If the user's plan does not call for deductibles, then this information will not display.
Three tabs: Explanation of Benefits, Plan Details, and Who's Covered
A “Back” button to return to the previous screen

The “Explanation of Benefits” tab is active by default. This tab will list out EOB statements. For each line item, it will display the following with the most recent statement at top:
Date of statement
Who the statement is for, showing first and last name
A “View” link

The patient user can click on the “View” link in each line item and the entries EOB statement will be displayed. When the patient user clicks/taps of the “Plan Details” tab, detailed information pertaining to the plan will be displayed. This information typically contains In-network and Out-of-Network options and pricing, as well as deductible information.

When a patient user clicks/taps on the “Who's Covered” tab, all parties that are covered by the insurance plan will be displayed. It will display the person's first and last name, as well as a photo of the person. If the user needs to make changes to the information of a specific insurance plan, they would click/tap on the “Edit Card Info” link. This will bring up the same user interface as if they were to manually enter the information with the following differences:
1. The previously selected insurance company would be highlighted but all of the company names would still be displayed. The user can change companies by selecting a new company name. If the user does not see their insurance company listed, they can click/tap a link to show all available insurance companies.
2. Their Group number and ID number are prefilled in the form fields. The user can now edit these fields as needed.
3. The policy holder's social security number is prefilled in the form field and the user can now edit this field.

Once they have edited any of these three steps, the user can save this information by clicking/tapping on the “Save” button, or cancel out of the process by clicking the “Cancel” button. If the user cancels out of the process, any data they have entered will not be saved and the original information will be retained.

If the patient user has successfully entered their insurance information, the screen will display the new information where the previous card was edited. Once the user has successfully added one insurance plan, the user interface will allow them to add secondary and tertiary plans. The process to do this is the same as the primary insurance—enter the information manually or via their computer or device's user interface built-in camera.

The purpose of the Insurance History section is to allow patient users to view important information from all of the health plans they have had in their lifetime. People often switch plans year-to-year, and certain claims remain unresolved. Allowing the user patient to access these claims is very beneficial. The patient user does not have to perform any actions for plans to appear in the history, the application will identify when the plan has expired and automatically populates this area with that information.

For each line item in this section, it will display the following with the most recent, but expired insurance information at the top:
Date of Coverage
Insurance Company Name
A “View Plan Details” link

When the patient user clicks/taps the “View Plan Details” link, they are presented with a screen that displays the following:
Image of the insurance card, containing company logo, Group number, and ID number
Dates of coverage
Policyholder's first and last names
Remaining deductible amount, shown in US currency. If the user's plan does not call for deductibles, then this information will not display.
Three tabs: Explanation of Benefits, Plan Details, and Who's Covered
A “Back” button to return to the previous screen.
   The three tabs would function exactly as mentioned above.

At the same time, the patient user will be prompted to set up all payment information appropriate to their needs including credit card, flexible spending account (FSA), PayPal, ApplePay/Google Wallet or other similar account. The patient user will be asked to provide Prescription/Pharmacy information including the name or names of convenient pharmacies for pick up or delivery of and medications or other medical supplies, provisions, or needs. A request will also be made that the patient user provide access to an email address or ICS file in order to provide for calendar integration for appointments and scheduling, as well as a photograph for use in the patient profile.

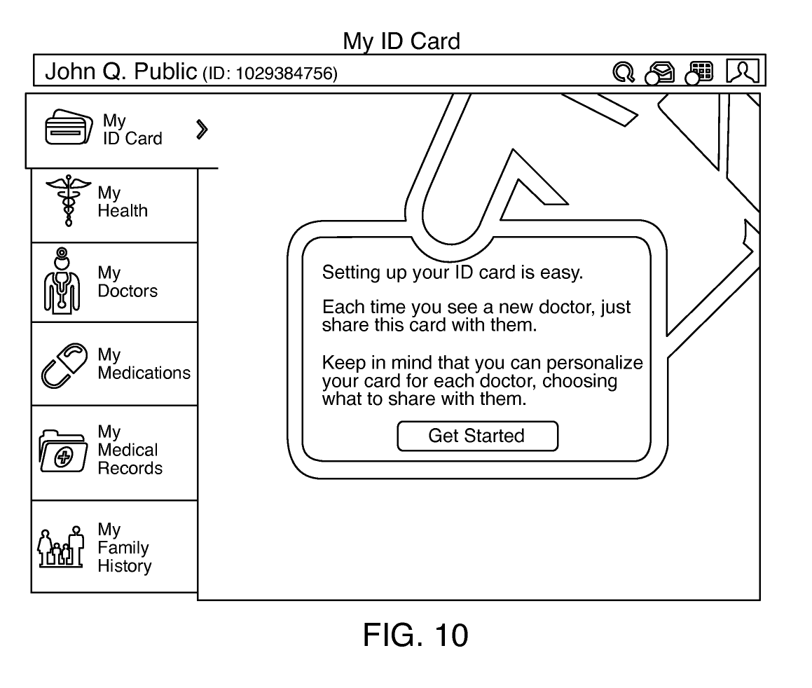

The ID Card is the primary method used to share a patient user's entire medical history. FIG. 10. It is also used to share their personal, insurance, and payment information. The ID Card does not share any information that the user has marked as private. The ID Card also contains a digital signature providing consent to HIPAA policies. The ID Card eliminates the need for a patient to ever fill out medical forms again.

The patient user has a choice as to what type of information they want to share each time they share with a new doctor, hospital, diagnostic center, or other medical provider. FIG. 11.
Entire medical history (including medications, allergies, social history, immunizations, surgeries, family history, scans, x-rays, all doctors' notes, and lab results)
Personal Information (including name, age, address, phone number, social security number, email address, emergency contact, driver's license number, employer, and marital status)
Insurance Information (company name, Group number, ID number)
Payment Information (typically used for co-payments)

In addition to selecting the type of information they want to share, the patient user can also enter chief complaints and symptoms, or the reason they are there to see that medical provider. With the exception of the medical history, the patient user has entered all of the information in the ID Card during the account set up process. The patient user can share their ID Card in two ways: (1) Using the desktop or native mobile version, the user would click/tap on ID Card from the menu and search for a doctor, lab, or hospital. Next they would select which one they want to share their information with. This can be done at any time prior to the first appointment and (2) If using the native mobile version, the application will detect which medical provider's office or location the user is currently located at by using geo-location. The patient user would then tap on ID Card from the menu and see the doctor/hospital name, title, photo, and address.

At this point, the patient user can choose to share by clicking/tapping the “Share Records” button, or cancel out of the process by clicking/tapping the “Cancel” button. When a user patient successfully shares their information, they are presented with a confirmation screen. FIG. 12. They will also receive notifications that their information has been successfully and securely shared, as well as a receipt for any co-payment. If the patient user has not already done so, the doctor will automatically be added to their My Doctors list. FIG. 13.

If the user has their information but changes their mind about seeing a doctor, hospital, or other provider, they can retract all of the shared information at any time. Once the information has been shared, the accessing doctor or hospital will always have the most current version of that information (medical, insurance, personal) whenever they view the patient's profile. FIGS. 8b, 8c, 8d, 8e and FIG. 8f. The only exception to this is when the patient marks any information as private. Private information will never be displayed to anyone other than the user/patient unless otherwise directed by the user.

The My Records area is a repository of documented medical records that the user has ever had. The files are displayed as real data, not scans or facsimiles. FIGS. 14, 15 and FIG. 16. The types of documents include, but are not limited to:
Doctor's note
SOAP note
Vital signs
Emergency room doctor's note
Triage note
Surgeon pre and postoperative note
Discharge note
Delivery note
Radiology report
EKG
Echocardiogram image
Lab blood and urine results
Biopsy result
Psychiatric evaluation
Dental records
Electrograph images
Tactile imaging
Ultrasound images
MRI images
PET scan
CT scan
X-ray

The documents are organized in a tabbed format by type to allow the patient user to easily find records. FIG. 14. Each record contains a date stamp and iconography is provided to provide help the user patient in order to differentiate between file types. Some files contain a photo created by the prescribing physician. An area entitled “Most Recent”, displays all files that were created within a one-year period, divided into 3 sections: this week, this month, and this year. FIG. 14. The patient user can click or tap on any document to display it in its entirety. The patient user, with either a mouse or with finger gestures, can manipulate records that consist of a series of images, such as an MRI. The patient user, either with a mouse or with finger gestures, can zoom in or zoom out of high resolution images to view finer details.

The patient user can search their entire medical records by using the search field located on the screen. The search engine is robust, allowing the patient user to search by:
Date
Doctor name
Radiologist name
Lab name
Hospital name
Imaging center name
Medical terms
Anatomy terms
Common terms (broken finger)
Document and file types
Test name
Acronyms (HbA1c) as well as the common term counterpart (glycated hemoglobin)
Positive results
Negative results
Out of range results
In range results

The display of results will vary depending on the search term, the screen could be divided into several sections to display different types of information. When tests are performed repeatedly (e.g., cholesterol), the data will be visually graphed over a period of time, allowing the user to see if a medical condition is improving or worsening. Clicking/tapping on any item in the search results will display the parent document in its entirety. The user patient can make any file or record private. When files are marked as private, they are never shared with anyone. Only the user can view these files, unless the user directs otherwise.

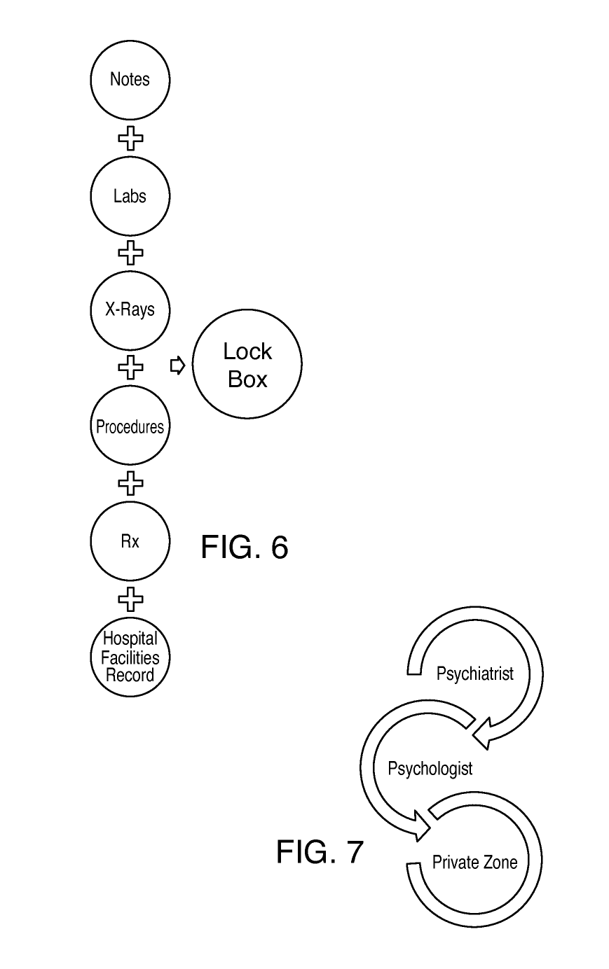

Files can be made private by using 2 methods. First, when using the native mobile application, the user patient touches and holds on the file until a menu is displayed. From this menu, the user can select either “Lock Box” or “Cancel.” FIG. 6. If the user patient chooses to make the record private, a lock icon will permanently appear over the file icon. The Lock Box contains information which the patient chooses not to share with a given medical provider or all medical providers. The patient may instead choose to place the information in the Lock Box which defines the security key in order to enter. The user patient can make records “public” by performing the same action, although the menu options would read “Remove from Lock Box” and “Cancel.” Second, when using the desktop web application, the user patient would right-click on a file until a menu is displayed. From this menu, the user can select either “Lock Box” or “Cancel.” If the user patient chooses to make the record private, a lock icon will permanently appear over the file icon. The user can make records “public” by performing the same action, although the menu options would read “Remove from Lock Box” and “Cancel.” Likewise, there may be instances when it is necessary to prevent the patient from viewing treatment notes which could threaten or jeopardize their therapy or care. (e.g., psychiatric notes related to treatment for a psychiatric illness or condition). In those instances, the physician or medical provider can choose to place treatment notes or records into a “Private Zone” by clicking or touching on a file icon until a message is displayed allowing them to choose or pick “Private Zone” or “Cancel”. If the physician or medical provider chooses “Private Zone”, a lock icon will appear over the file icon pertaining to the specific notes or records. Access to the “Private Zone” area will only be available to the physician or medical provider based upon their own identifying features and their inclusion in the “My Doctors” area. FIG. 7.

The Notifications area is used to inform the user patient when new records have been posted and are ready to be viewed. FIG. 17. In the desktop web application, notifications can be accessed through an icon on the top menu. On the native mobile application, notifications may be displayed on the device's lock screen depending on how the user has set their preferences. Additionally, new records may be posted on the authenticated home screen or the My Health area.

The “My Doctors” area is used to easily communicate with all of the doctors a user patient interacts with to manage their healthcare. FIG. 13. The list contains all of the doctors the user patient has ever been treated by, even doctors the user no longer sees for their current healthcare management. Any doctor, whether it is a primary care physician, psychiatrist, dentist, or oncologist will be displayed. Doctors are listed in alphabetical order. If the list of doctors reaches more than 20, then sorting and filtering controls will display the list. These controls allow the user to display the list by A-Z or Z-A or display the list by most recent visit. FIG. 13. For each doctor listed, the following will display:
Photo or avatar (as uploaded by doctor)
Full name including prefix and suffix
Title (Primary Care, Ophthalmology, Cardiology, etc.)
Full address, including street address, user interface number, city, state, and zip code
Phone number
Date of last visit, except in the case where the user has not seen the doctor yet

For each doctor listed, the user patient can perform several functions:

Make an Appointment—when the user clicks/taps on the Make an Appointment button, the integrated calendar will display showing the user's home/work calendar, as well as the selected doctor's available time. FIG. 17. Get Directions—the user can click/tap on the “Directions” link. Doing this action will call up a map and driving directions from the user's home address to the doctor's office. Once the map is displayed, the user can alter the starting point, in case their need directions from their job or another location. Call Doctor's Office—when the user clicks/taps on the doctor's phone number that is displayed, this will initiate a phone call depending on the device this is taking place on. For instance, if this action were performed on a smart phone, it would call up the phone feature. If this action is performed on a laptop or desktop computer, it may call up Skype, Facetime, or other apps that allow you to make calls through the computer. Drop Doctor—this action allows a user to remove a doctor from their list and the doctor's information will no longer be displayed. By dropping a doctor, that doctor would still have access to the user's medical records to date, but would not receive any future medical or health information. View Notes from Previous Visit—the user can access notes from their previous visit with that doctor by clicking a link under the date of the last visit. FIG. 14.

If a doctor is no longer practicing medicine for any reason, the display will change to indicate this to the user. The actions listed above will no longer be active, with the exception of Drop Doctor and View Notes from Previous Visit. FIG. 14.

The user patient can perform a search for new doctors, hospitals, imaging centers, etc., by using the search field. They can also search doctors that are only in their insurance network by selecting a checkbox. The search engine is robust, allowing the user patient to enter a doctor's name, specialty, or even health conditions that doctors treat. If a user misspells a term, the search engine will display results that best match what the user has entered. After a search is performed, a list of doctors or facilities that match the search criteria will be displayed, showing the closest proximity to the user's address at the top of the list. For each doctor or facility showing in the search results, the following will display:
Distance, in miles, from the user's home address
Doctor or facility photo, avatar, or logo
Full name including prefix and suffix
Title (Primary Care, Ophthalmology, Cardiology, etc.)
Full address, including street address, user interface number, city, state, and zip code
Phone Number
Rating (3 out of 5 stars) if available

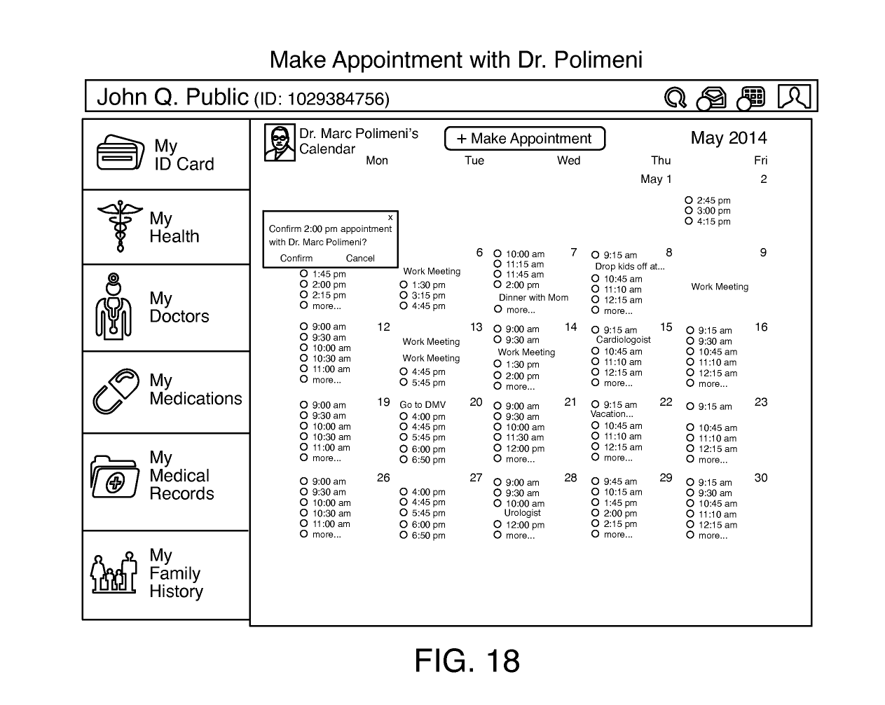

Also shown for each search result are the following, except in certain cases, such as hospitals, where these actions are not available: Make an Appointment—when the user patient clicks/taps on the Make an Appointment button, the integrated calendar will display showing the user's home/work calendar, as well as the selected doctor's available time. FIG. 18. Get Directions—the user patient can click/tap on the “Directions” link. Doing this action will call up a map and driving directions from the user patient's home address to the doctor's office. Once the map is displayed, the user patient can alter the starting point, in case their need directions from their job or another location.

If a user patient navigates to the integrated calendar via the Calendar icon, and clicks/taps the “Make an Appointment” button, the same list of doctors will appear showing the same information. The user patient can also perform a search for a new doctor or facility from this same interface. The search capabilities would perform exactly as outlined above. Doctor information from the My Doctors list, such as name and photo, also appear throughout the application, most notably on doctor's notes, lab results, calendars, and notifications. FIG. 13 and FIG. 14.

The integrated calendar feature allows a user to easily schedule doctor, lab, or imaging center appointments. Since the calendar is integrated, it will show the user's home, work, and holiday calendars (or any user-created calendar), as well as the calendar of the doctor, lab, or imaging center they are trying to schedule time with. This ease of use allows the user patient to schedule a time that works best with their home and work lives. The calendar is integrated throughout the system. FIG. 18. Key points of entry include:
Clicking/tapping on the calendar icon in the top navigation
Clicking/tapping the “Make Appointment” button from the “My Doctors” section
Clicking/tapping the “Make Appointment” button after performing a search for a new doctor, lab, or imaging center
Clicking/tapping from a reminder Notification, or Notifications that appear on the authenticated home screen (My Health)
Clicking/tapping from a test result, doctor note, scan or x-ray.

The user patient can control how the calendar displays. The calendar can be viewed by day, week, or month. When viewing the calendar by day or week, the hours of the day will display. The user patient can navigate forwards and backwards through the days, weeks, months, and years. On the desktop version, the default view is by month. On the native app version, the default view is by day. If a user accesses the calendar via the icon in the top navigation, the calendar will only display the user patient's home and/or work appointment. It will not display available appointment slots, unless an appointment has been previously scheduled. Color-coding is employed to help the user patient differentiate between home, work, and doctor appointments. The user patient can initiate an appointment with a doctor, lab, or imaging center by performing a search directly from the calendar or by navigating to the “My Doctors” area. FIG. 13.

Once the user patient has selected a doctor, lab, or imaging center, the calendar will display all available time slots from which an appointment can be made, as well as any appointment slots from the user patient's home and/or work calendar. It will also display the name and photo of the doctor, lab, or imaging center. The calendar does not display time slots that are not available. The user patient can schedule by clicking/tapping on an available time slot. A message will appear showing the selected time and doctor, lab, or imaging center's name asking the user if they would like to confirm that time slot. The user patient can choose either “Confirm” or “Cancel.” If the user patient selects “Cancel,” the message will disappear and the calendar will be seen in its previous state. If the user patient selects “Confirm,” the message will disappear and the selected time slot will change color and display the following: [Doctor's Name|time|Confirmed]. Also, when the user patient confirms an appointment, a notification will appear in the Notification area. FIG. 17.

A user patient can easily cancel an appointment. This can be achieved by clicking/tapping on the existing appointment in the calendar. The user patient will be presented with a message asking if they would like to cancel that appointment with the option to select “Yes” or “No.” Selecting “No” will dismiss the message and the previous state of the calendar will be seen. Selecting “Yes” will remove the appointment from the calendar. Depending on which state the user patient is viewing the calendar in, available time slots for the doctor, lab, or imaging center may or may not be present. When the user cancels an appointment, a notification will appear in the Notification area. FIG. 17.

If the user patient chooses to reschedule an appointment, the process is identical to creating a new appointment. Appointments can also be made, rescheduled or cancelled by a doctor's office, lab, or imaging center, as long as they enter the appointment into the system, the appointment will appear in the user patient's calendar. The calendar icon in the top navigation incorporates a numeric value to indicate the number of upcoming scheduled appointments. The calendar can also be integrated with a user's other calendar applications, such as Google Calendar or the Android or iOS calendars. Additionally, the calendar will automatically detect the time zone the user is in. If a user changes time zones (due to travel, etc.), the calendar will automatically reflect the appropriate time zone.

The Medications tab displays all prescription medicines, devices, and apparatuses associated with the user patient. The list is divided into two main sections: currently taking, and no longer taking. Within each of these sections, the items are displayed with the most recent prescription at the top of the list. FIG. 19. For each item in the list, the following will display:
Medication/device name—both the branded and unbranded versions
Image of medication/device
The prescribed dosage amount (mg, mcg, etc.)
How and when the medication/device should be used
Prescribing doctor's name
Date of last refill
Amount of refills remaining
RX number
Quantity
Information icon

When the user patient clicks/taps the information icon, the respective medication/device information will display. FIG. 19. The information will display as a model over the Medication list. This information typically includes:
Medication/device name—both the branded and unbranded versions
Conditions that the medication/device is used to treat
Side effects
Warnings
How to use
Pregnancy risk
Drug class
   Certain terms within the information may be hyperlinked, such as “High blood pressure.” This allows the user patient to discover the meaning/definition of these terms. Associated with each item in the Medications list are buttons that allow the user to perform a specific action with each item. These include:
Refill Now—this action allows the user to refill the prescription online from a mail order pharmacy (i.e., Allscripts, Medco, etc.). When the user patient performs this action, a screen will present the name, dosage, image, information icon, and cost of the prescription. This screen will also display the user patient's shipping address, along with several payment options (pay with credit card, PayPal, etc.).
Request Refill—this action allows the user patient to request a refill directly from the prescribing doctor. It will also allow the user patient to schedule an appointment or call the doctor's office.
Call Pharmacy—this action allows the user patient to call the pharmacy where the prescription was filled without dialing the phone number.
Auto-refill—when this option is “on,” then the prescription will be automatically refilled at the proper date and the user's payment method will be charged the appropriate amount. When this setting is “off,” the user must manually refill the prescription. The user patient may also cancel out of any of these actions.

When the user patient performs any of these actions, a message will be generated by the Notification Center confirming the user's actions. Additional notifications may also occur, such as delivery notices or refill reminder dates. When adverse effects are identified due to the combination of 2 or more prescription drugs that the user patient is taking, onscreen messaging will appear at the top of the screen, notifying the user patient to discontinue taking the medications until speaking with his or her doctor. Messaging would also appear if a medication has been recalled and is no longer safe to take.

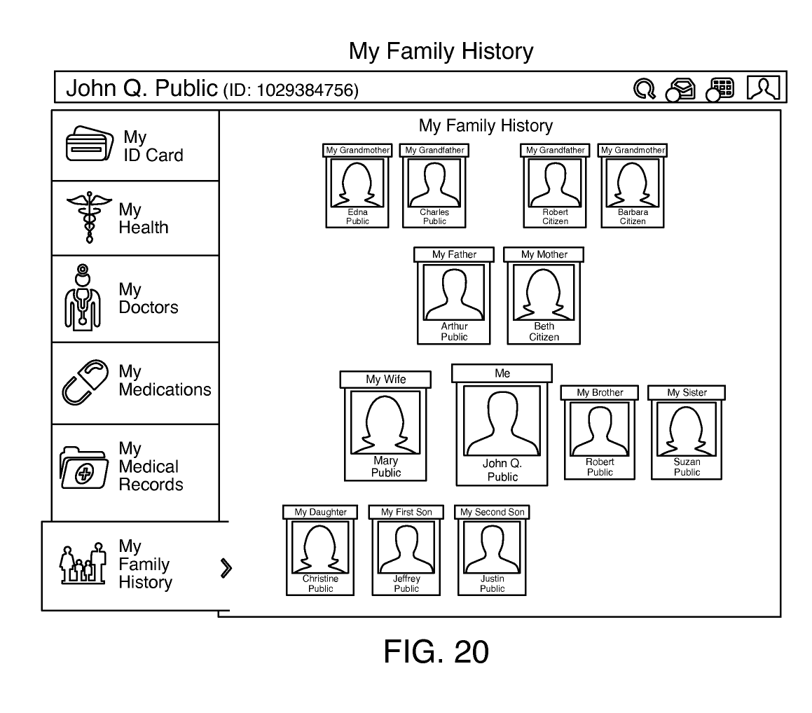

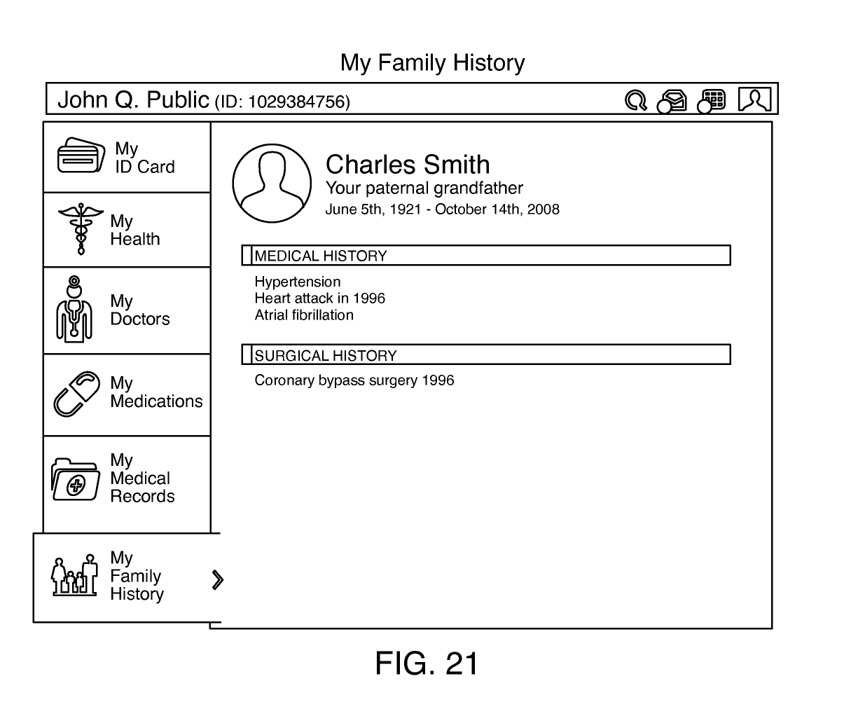

The Family History area is used to identify, track, and notify the user patient of any medical conditions that are inherent to their bloodline. The family members that are displayed include maternal and paternal grandparents, parents, sibling(s), spouse(s) and children. The user patient can click on the photo of each family member and see the full name, date of birth, date of death (if applicable), and the medical and surgical histories that may be relevant to the user patient's health. It does not display the family member's entire medical history or health records. FIG. 20 and FIG. 21.

Any medical risks that are identified will be displayed via a bar graph, indicating whether the risk is low, medium or high. Color-coding is also used to indicate risk level. Examples of risk include, but are not limited to, high blood pressure, diabetes, or certain cancers. The bar graph will also be used to indicate to the user is their risk levels for a certain medical condition have increased or decreased over time. FIG. 22.

User patients can click/tap on the bar graph to see more information about the medical condition and which family members have these conditions. Information on how to lower the risk or treat these conditions will also be displayed. Lastly, any test or lab results will be displayed to allow the user to understand and manage their risk levels.

Names and photos of certain family members, primarily spouses and children, will be displayed under the insurance information area. The purpose is to clearly show which family members are covered by the insurance plan, as well as any explanation of benefits for those family members covered.

The notifications area is used to inform the user patient of important information that pertains to managing their healthcare. FIG. 17. Notifications can be accessed through an icon in the top menu. The icon incorporates a numeric value to indicate the number of unread notifications. Additionally, an area in the upper right of the authenticated home screen (My Health) displays new, unread notifications. These notifications may be abbreviated, showing only the first 25 characters of the subject line, as well as the posting date. In the native mobile app, notifications can also be presented on a user patient's lock screen depending on how the user has set their preferences on their device.

Notifications can be displayed in 2 states: read and unread. While it is impossible to determine if a user patient has actually “read” a notification, the state indicates if the user has tapped or clicked on the notification. A colored dot or icon is used to indicate an unread state, whereas no dot or icon would indicate the read state. Notifications fall under two primary categories; specifically, those that request an action from the user patient and those that do not request an action from the user patient. FIG. 17. Examples of notifications that would require an action from the user patient include:
Refill a prescription
Schedule a follow up visit with the doctor
Schedule a yearly physical with a doctor
Notify the user if a doctor, lab, or imaging center needs to reschedule an appointment
Notify the user if a doctor has retired or left a practice
Reminder to receive vaccinations (flu, tetanus, etc)
Update an expiration date on a credit card
Contact their doctor if adverse reactions are identified with their medications
A medication has been recalled or pulled off the market
Track a prescription order
Track a contact lens order
Confirm sharing of medical records with a new doctor, lab, or hospital
Notify the user if a medical condition is identified from the family history
Subscription set to expire for use of the system—payment requested
Updates to HIPAA laws/policies
   Examples of notification that would not request an action from the user patient may include:
Confirmation of account creation
Confirmation of new family members added
New doctor or triage notes are available
New lab results are available
New x-rays or scans are available
A family member is at the emergency room
Confirmation that the user is at the emergency room
Confirmation of a scheduled doctor's appointment
Confirmation of a cancelled doctor's appointment
Confirmation of changes to a user account setting
Confirmation that medical records have been shared with a new doctor, lab, hospital, or imaging center
Confirmation that a new doctor has been added to their “My Doctors” list
Confirmation of dropping a doctor from their “My Doctors” list—no longer allowing that doctor access to future records
Notification of approximate wait time for a doctor
Confirmation of a new proxy or emergency contact person
Co-payment has been charged to credit card, FSA, or other payment method
Receipt for co-payment
Receipt for subscription renewal to the system
New EOB available
Medical records have been set to private.

Those of ordinary skill in the art will recognize that the embodiments just described merely illustrate the principles of the present invention. Many obvious modifications may be made thereto without departing from the spirit or scope of the invention as set forth in the appended claims.

1. A medical records management system comprising a web based server device including a processor device and at least one computer storage medium, and at least one computer storage medium storing a database and data instructions, wherein the data instructions are executable by the processor device to:
register a user patient by a patient user identifier with a server device by receiving the patient user data through a web interface;
store the user patient data in the database at the server device;
allow the user patient to authorize third party health care providers access to the user data on the database at the server device;
receive an electronic medical record pertaining to the patient user through a web interface from an authorized third party health care provider in a standard protocol for the transfer of clinical and administrative data between software applications used by health care providers and categorize the electronic medical record in the patient user data in the database as a function of the standard resource code;
allow the user patient and the authorized third party health care providers to access the user patient's medical records through a graphical user interface.

2. The medical records management system of claim 1, wherein the electronic medical record pertaining to the patient user received through a web interface from an authorized third party health care provider is in non-standard protocol for the transfer of clinical and administrative data between software applications used by health care providers, wherein the instructions are further executable by the processor to:
translate the electronic medical record pertaining to the user patient into standard protocol for the transfer of clinical and administrative data between software applications used by health care providers and categorize the electronic medical record in the user patient data in the database as a function of the standard resource code;
allow the user patient and the authorized third party health care providers to access the user patient's medical records through a graphical user interface.

3. The medical records management system of claim 1, wherein the instructions are further executable by the processor to:
remove the user patient identifier from the electronic medical records in the patient user data in the database;
search the electronic medical records in the user patient data in the database;
generate search results.

4. The medical records management system of claim 2, wherein the instructions are further executable by the processor to:
remove the user patient identifier from electronic medical records in the patient user data in the database;
search the electronic medical records in the user patient data in the database;
generate search results.

5. The medical records management system of claim 1, wherein the instructions are further executable by the processor to:
associate the user patient data in the user patient database with a human-like anatomical figure graphical user interface;
place the user patient data in appropriate locations on the human-like anatomical figure graphical user interface.

6. The medical records management system of claim 2, wherein the instructions are further executable by the processor to:
associate the user patient data in the patient user database with a human-like anatomical figure graphical user interface;
place the user patient data in appropriate locations on the human-like anatomical figure graphical user interface.

7. A method of importing and managing electronic health records from various sources in standard protocol for the transfer of clinical and administrative data between software applications used by health care providers onto a medical records management system wherein the medical records management system comprises a web based server device including a processor device and at least one computer storage medium, and at least one computer storage medium storing a database and data instructions, and wherein the method comprises:
registering a user patient by receiving a patient user identifier through a web interface provided by a web server device;
receiving and storing the user patient data in a database accessible by the web server device;
authorizing third party health care providers access to the user patient data on the database at the server device;
receiving an electronic medical record pertaining to the user patient through a web interface from an authorized third party health care provider in a standard protocol for the transfer of clinical and administrative data between software applications used by health care providers and categorize the electronic medical record in the patient user data in the database as a function of the standard resource code;
accessing the user patient's electronic medical records through a graphical user interface.

8. A method of importing and managing electronic health records from various sources in non-standard protocol for the transfer of clinical and administrative data between software applications used by health care providers onto a medical records management system wherein the medical records management system comprises a web based server device including a processor device and at least one computer storage medium, and at least one computer storage medium storing a database and data instructions, and wherein the method comprises:
registering a user patient by receiving a user patient identifier through a web interface provided by a web server device;
receiving and storing the user patient data in a database accessible by the web server device;
authorizing third party health care providers access to the user patient data on the database at the server device;
receiving an electronic medical record pertaining to the patient user through a web interface from an authorized third party health care provider in a nonstandard protocol for the transfer of clinical and administrative data between software applications used by health care providers and categorize the electronic medical record in the patient user data in the database as a function of the standard resource code;
converting the electronic medical record pertaining to the patient user into standard protocol for the transfer of clinical and administrative data between software applications used by health care providers and categorize the electronic medical record in the patient user data in the database as a function of the standard resource code.
accessing the user patient's electronic medical records through a graphical user interface.

9. A method as in claim 7, wherein the method further comprises:
associating the user patient data in the user patient database with a human-like anatomical figure graphical user interface;
placing the user patient data in appropriate locations on the human-like anatomical figure graphical user interface.

10. A method as in claim 8, wherein the method further comprises:
associating the user patient data in the user patient database with a human-like anatomical figure graphical user interface;
placing the user patient data in appropriate locations on the human-like anatomical figure graphical user interface.

11. A method of viewing user patient data stored on the medical records management system where the medical records management system comprises a web based server device including a processor device and at least one computer storage medium, and at least one computer storage medium storing a database and data instructions, and wherein the method comprises:
accessing the medical records management system of a specific user patient by means of the human-like anatomical figure;
selecting an area of gross anatomy on the human-like anatomical figure with an input device;
linking to all relevant medical information contained within the medical records management system pertaining to that portion of the gross anatomy of the human-like anatomical figure;
zooming into that portion of the human-like anatomical figure;
viewing images or records pertaining to that portion of the human-like anatomical figure.

12. A method of viewing user patient data stored on the medical records management system at a specific time in the user patient's life where the medical records management system comprises a web based server device including a processor device and at least one computer storage medium, and at least one computer storage medium storing a database and data instructions, and wherein the method comprises:
accessing the medical records management system of a specific user patient by means of the human-like anatomical figure with an input device;
adjusting the user patient time line indicator within the screen of the human-like anatomical figure with an input device;
modifying the information depicted on the human-like anatomical figure as a function of the indicator location on the user patient time line indicator;
viewing images or records of the user patient pertaining to that portion of the human-like anatomical figure for the specific time in the user patient's life selected.

13. A method for health care providers to up load data to the medical records management system at a specific time in the user patient's life where the medical records management system comprises a web based server device including a processor device and at least one computer storage medium, and at least one computer storage medium storing a database and data instructions, and wherein the method comprises:
receiving a user patient authorization to access the user patient's database on the medical records management system;
creating an electronic health record based on the examination or treatment of the patient;
transmitting the electronic health record to the user patient's database on the medical records management system.

14. A method of scheduling office visits to health care providers by interfacing the user patient's personal calendar with that of the health care providers on the medical records management system where the medical records management system comprises a web based server device including a processor device and at least one computer storage medium, and at least one computer storage medium storing a database and data instructions, and wherein the method comprises:
uploading the user patient's calendar to the medical records and management system database;
uploading the health care provider's calendar to the medical records and management system database;
synchronizing the user patient's calendar and the health care provider's calendar;
identifying time frames when both calendars provide open times for an office visit by the user patient;
selecting a time for an office visit based upon the open times;
updating both the user patient and medical service provider calendar with the appointment.

15. A method of automatically providing Health Insurance Portability and Accountability Act complaint medical records authorization to all health care providers when a health care provider is granted access a user patient's medical records management system database where the medical records management system comprises a web based server device including a processor device and at least one computer storage medium, and at least one computer storage medium storing a database and data instructions, and wherein the method comprises:
storing an executed Health Insurance Portability and Accountability Act complaint medical records authorization form on the user patient's medical records management system database;
providing the health care providers with access to the user patient's medical records management system database;
transmitting the health care service provider a Health Insurance Portability and Accountability Act complaint medical records authorization form to upload medical treatment information to the user patient's medical records management system database to the health care provider;

16. A method of revealing potential adverse interactions of medications prescribed to a user patient on the user patient's medical records management system database where the medical records management system comprises a web based server device including a processor device and at least one computer storage medium, and at least one computer storage medium storing a database and data instructions, and wherein the method comprises:
loading the prescription drug data sheet into the medical records management system database for each prescription drug prescribed to the user patient;
comparing the prescription drug data sheets of the prescription drugs associated with the user patient on the database;
sending an electronic message identifying any potential adverse prescription drug interactions to the user patient and health care providers associated with the prescriptions that conflict.

17. A method of revealing the selection of an out-of-network health care provider on the user patient's medical records management system database where the medical records management system comprises a web based server device including a processor device and at least one computer storage medium, and at least one computer storage medium storing a database and data instructions, and wherein the method comprises:
loading the in-network health care provider information associated with a user patient into the patient's medical records management system database ;
comparing the in-network health care provider information to the health care provider login information on the user patient's medical records management system database;
sending an electronic message identifying any out-of-network health care providers accessing the patient's medical records management system database to the user patient.

18. A method of uncovering duplicative or unnecessary medical testing or procedures for a user patient on the user patient's medical records management system database where the medical records management system comprises a web based server device including a processor device and at least one computer storage medium, and at least one computer storage medium storing a database and data instructions, and wherein the method comprises:
entering an order for a test or procedure for a user patient into the patient's medical records management system database;
comparing the order for a test or procedure with all tests and procedures in the user patient's medical records management system database;
identifying tests or procedures in the user patient's medical records management system database similar to the ordered test or procedure;
sending an electronic notification to the user patient and the health care provider ordering the test or procedure identifying the similar tests or procedures.

19. A method of selecting medications which are covered under the user patient's health insurance plan on the user patient's medical records management system database where the medical records management system comprises a web based server device including a processor device and at least one computer storage medium, and at least one computer storage medium storing a database and data instructions, and wherein the method comprises:
loading the user patient's drug prescription plan database onto the patient's medical records management system database;
prescribing a mediation to a user patient in the medical records management system database;
comparing the prescribed medication to the mediations in the user patient's drug prescription plan database;
sending an electronic notification to the user patient and the health care provider prescribing the medication advising whether the medication is contained in the user patient's drug prescription plan.

20. A method of searching the medical records management system where the medical records management system comprises a web based server device including a processor device and at least one computer storage medium, and at least one computer storage medium storing a database and data instructions, and wherein the method comprises:
removing the user patient identifier from the medical records management system database;
submitting a query to the medical records management system database;
returning the query results.
